(19) United States
(12) Patent Application Publication
(10) Pub. No.: US 2023/0311245 A1
(43) Pub. Date: Oct. 5, 2023

(54) LASER PROCESSING OF A PARTLY TRANSPARENT WORKPIECE USING A QUASI-NON-DIFFRACTIVE LASER BEAM

(71) Applicant: TRUMPF Laser- und Systemtechnik GmbH, Ditzingen (DE)

(72) Inventors: Daniel Flamm, Ludwigsburg (DE); Jonas Kleiner, Leonberg (DE)

(21) Appl. No.: 18/331,971

(22) Filed: Jun. 9, 2023

Related U.S. Application Data
(63) Continuation of application No. PCT/EP2021/079558, filed on Oct. 25, 2021.

(30) Foreign Application Priority Data
Dec. 11, 2020 (DE) 10 2020 133 145.2

(51) Int. Cl. B23K 26/064; B23K 26/402

(52) U.S. Cl. CPC B23K 26/064; B23K 26/402

(57) ABSTRACT

A method for material processing of a workpiece includes radiating a pulsed raw laser beam into an optical beam shaping system in order to form a quasi-non-diffractive laser beam with a focal zone extending in a longitudinal direction for the material processing of the workpiece. The optical beam shaping system is configured to impose a phase onto a beam cross section of the raw laser beam for forming phase-imposed laser radiation. The method further includes focusing the phase-imposed laser radiation into the workpiece so that the quasi-non-diffractive laser beam is formed and the focal zone has an intensity distribution that is adjustable along the longitudinal direction. The phase imposed on the beam cross section of the raw laser beam is set so that the intensity distribution of the quasi-non-diffractive laser beam in the focal zone is at least approximately constant in the longitudinal direction.

### CROSS REFERENCE TO RELATED APPLICATIONS

This application is a continuation of International Application No. PCT/EP2021/079558 (WO 2022/122238 A1), filed on Oct. 25, 2021, and claims benefit to German Patent Application No. DE 10 2020 133 145.2, filed on Dec. 11, 2020. The aforementioned applications are hereby incorporated by reference herein.

### FIELD

Embodiments of the present invention relate to a method for material processing of a partly transparent workpiece using a quasi-non-diffractive beam. Further, embodiments of the present invention relate to a laser processing apparatus.

### BACKGROUND

Independently of linear absorption, a workpiece can be processed with the aid of the nonlinear absorption of high-intensity laser radiation. To this end, one or more modifications can be produced in a workpiece using the high-intensity laser radiation if a nonlinear absorption of the high-intensity laser radiation occurs in the material of the workpiece. Modifications can have an effect on the structure of the material and can be used for example for drilling, for separating by way of induced stresses, for bringing about a modification of the refraction behavior or for selective laser etching. In this respect, see for example the applicant's applications WO 2016/079062 A1, WO 2016/079063 A1, and WO 2016/079275 A1 in the field of processing substantially transparent workpieces. Beam shaping elements and optical systems with which it is possible to provide slender beam profiles which are elongated in the beam propagation direction and have a high aspect ratio for the laser processing are described for example in the cited WO 2016/079275 A1.

The material of the workpiece exhibits linear absorption of laser radiation in the case of partly transparent workpieces. For example, partly transparent workpieces have an absorption (independently of the intensity of the radiated-in laser radiation) with absorption coefficients ranging from approx. 0.1/mm to approx. 2.5/mm, corresponding to typical transmissions ranging from 90% to 10% per millimeter material thickness, for example 60% per 1 mm glass thickness. Laser processing of partly transparent workpieces differs from the laser processing of a material substantially transparent to the laser radiation, which is to say this material has a negligible linear absorption, by virtue of the laser radiation propagating in the material being additionally linearly absorbed by the material. Consequently, more laser radiation is absorbed, the further the laser radiation propagates through the material.

### SUMMARY

Embodiments of the present invention provide a method for material processing of a workpiece. The method includes radiating a pulsed raw laser beam into an optical beam shaping system in order to form a quasi-non-diffractive laser beam with a focal zone extending in a longitudinal direction for the material processing of the workpiece. The optical beam shaping system is configured to impose a phase onto a beam cross section of the raw laser beam for forming phase-imposed laser radiation. The method further includes focusing the phase-imposed laser radiation into the workpiece so that the quasi-non-diffractive laser beam is formed and the focal zone has an intensity distribution that is adjustable along the longitudinal direction. The workpiece includes a material that is partly transparent to the quasi-non-diffractive laser beam and exhibits an intensity-independent linear absorption in a frequency range of the quasi-non-diffractive laser beam. The phase imposed on the beam cross section of the raw laser beam is set so that the intensity distribution of the quasi-non-diffractive laser beam in the focal zone is at least approximately constant in the longitudinal direction.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows subfigures for elucidating quasi-non-diffractive beams in comparison with a Gaussian beam;

FIG. 2 shows a schematic diagram of a laser processing apparatus for material processing;

FIGS. 3A to 3F show schematic diagrams for elucidating the formation of a quasi-non-diffractive beam in a partly transparent workpiece;

FIG. 4 shows schematic illustrations for elucidating the effect of the linear absorption on a quasi-non-diffractive beam;

FIG. 5 shows a flowchart for elucidating a method for material processing of a workpiece consisting of a partly transparent material;

FIGS. 6A to 6C show exemplary representations of radial height profiles of an axicon and a modified axicon, and of a radial phase profile;

FIG. 7 shows a schematic illustration for elucidating the adjustment of a longitudinal intensity distribution of the quasi-non-diffractive beam in the propagation direction in the presence of linear absorption in a workpiece by setting the phase imposition;

FIG. 8 shows schematic subfigures in relation to a quasi-non-diffractive beam, formed according to the invention, in a partly transparent workpiece, and

FIG. 9 shows a flowchart for elucidating a method for forming a beam shaping element, in particular a diffractive optical beam shaping element.

### DETAILED DESCRIPTION

Embodiments of the present invention can enable laser processing of a partly transparent workpiece using a focal zone which is elongated in the propagation direction. In particular, beam shaping approaches such as have been developed for the laser processing of transparent workpieces are intended to become usable even for partly transparent workpieces.

In one aspect of this disclosure, a method for material processing of a workpiece using a quasi-non-diffractive laser beam, the workpiece having a material which is partly transparent to the quasi-non-diffractive laser beam and which exhibits a laser radiation intensity-independent linear absorption in relation to laser radiation in the frequency range of the quasi-non-diffractive laser beam, comprises the steps of:

radiating a pulsed raw laser beam into an optical beam shaping system in order to form a quasi-non-diffractive laser beam which has a focal zone extending in a longitudinal direction and which serves for material processing of the workpiece, with the optical beam shaping system being used to impose a phase onto a beam cross section of the raw laser beam for the purpose of forming phase-imposed laser radiation, and

focusing the phase-imposed laser radiation into the partly transparent material of the workpiece so that the quasi-non-diffractive laser beam is formed and the focal zone has an intensity distribution which is adjustable along the longitudinal direction, with

the phase imposition being set in such a way that, when the phase-imposed laser radiation is focused into the partly transparent material of the workpiece, a resultant intensity distribution of the quasi-non-diffractive laser beam in the focal zone is at least approximately constant in the longitudinal direction.

In a further aspect, this disclosure relates to a laser processing apparatus for material processing of a workpiece using a quasi-non-diffractive laser beam, the workpiece having a material which is partly transparent to the quasi-non-diffractive laser beam and which exhibits a laser radiation intensity-independent linear absorption in relation to laser radiation in the frequency range of the quasi-non-diffractive laser beam. The laser processing apparatus comprises a laser beam source, which emits a pulsed laser beam, and an optical beam shaping system for beam shaping of the laser beam for the purpose of forming the quasi-non-diffractive laser beam with a focal zone extending in a longitudinal direction. The optical beam shaping system comprises a beam adjustment optical unit configured to output the laser beam as a raw laser beam with a beam diameter, and a beam shaping element configured to impose a phase on a beam cross section of the raw laser beam in order to form phase-imposed laser radiation for a specified beam diameter of the raw laser beam, in such a way that, when the phase-imposed laser radiation (5_PH) is focused into the partly transparent material of the workpiece (3), the quasi-non-diffractive laser beam (5) is produced with a resultant intensity distribution which is at least approximately constant in the longitudinal direction in the focal zone. The laser processing apparatus further comprises a workpiece mount for mounting the workpiece, with the optical beam shaping system and/or the workpiece mount being configured to bring about a relative movement between the workpiece and the quasi-non-diffractive laser beam, in the case of which the quasi-non-diffractive laser beam is positioned along a scanning trajectory in the material of the workpiece.

In a further aspect of this disclosure, a method for material processing of a workpiece using a quasi-non-diffractive laser beam, the workpiece having a material which is partly transparent to the quasi-non-diffractive laser beam and which exhibits a laser radiation intensity-independent linear absorption in relation to laser radiation in the frequency range of the quasi-non-diffractive laser beam, comprises the steps of:
radiating a pulsed raw laser beam into an optical beam shaping system in order to form a quasi-non-diffractive laser beam which has a focal zone extending in a longitudinal direction and which serves for material processing of the workpiece, with a phase being imposed on a beam cross section of the raw laser beam by means of the optical beam shaping system so that the quasi-non-diffractive laser beam at the focal zone has an intensity distribution in the longitudinal direction which is adjustable, in particular varyingly adjusted, and variable, and
setting the phase imposition in such a way that a resultant intensity distribution of the quasi-non-diffractive laser beam upon radiation into the partly transparent material of the workpiece is at least approximately constant in the longitudinal direction at the focal zone.

In a further aspect of this disclosure, a method for material processing of a workpiece using a quasi-non-diffractive laser beam, the workpiece having a material which is partly transparent to the quasi-non-diffractive laser beam and which exhibits a laser radiation intensity-independent linear absorption in relation to laser radiation in the frequency range of the quasi-non-diffractive laser beam, comprises the steps of:
radiating a pulsed raw laser beam into an optical beam shaping system configured to output phase-imposed laser radiation for the purpose of forming a quasi-non-diffractive laser beam which has a focal zone extending in a longitudinal direction and which serves for material processing of the workpiece, with a phase being imposed on a beam cross section of the raw laser beam by means of the optical beam shaping system so that the quasi-non-diffractive laser beam in the focal zone has a variable intensity distribution in the longitudinal direction if linear absorption is not taken into account,
setting the phase imposition in such a way that, when the phase-imposed laser radiation is radiated into the partly transparent material of the workpiece, a resultant intensity distribution of the quasi-non-diffractive laser beam in the focal zone is at least approximately constant in the longitudinal direction, and
radiating the phase-imposed laser radiation into the partly transparent material of the workpiece in order to form the quasi-non-diffractive laser beam for the material processing.

A further aspect of this disclosure comprises a method for forming a beam shaping element, in particular a diffractive optical beam shaping element, provided for use within the scope of material processing of a workpiece in an optical beam shaping system for the beam shaping of a quasi-non-diffractive laser beam from a raw laser beam, the workpiece having a material which is partly transparent to the quasi-non-diffractive laser beam and exhibits a laser radiation intensity-independent linear absorption in relation to laser radiation in the frequency range of the quasi-non-diffractive laser beam. The method includes the steps of:
providing a linear absorption parameter of the partly transparent material in the frequency range of the quasi-non-diffractive laser beam, in particular by measuring a linear absorption parameter;
defining a target intensity distribution as a resultant intensity distribution to be obtained in the workpiece along an optical axis of the quasi-non-diffractive laser beam, in the case of which an intensity of the target intensity distribution is, in at least one portion, above an intensity threshold for a nonlinear absorption, which is dependent on a respectively present laser radiation intensity, for the purpose of modifying the material of the workpiece at a plurality of positions along the optical axis;
specifying a transverse beam profile, in particular a beam diameter, of the raw laser beam, onto which a two-dimensional phase distribution should be imposed;
calculating a two-dimensional phase distribution for the transverse beam profile by:
   subdividing the transverse beam profile into beam cross-sectional regions, in particular beam cross-sectional regions with a ring-shaped form,
   assigning phase increases, in particular identical linear phase increases, in the radial direction over the beam cross-sectional regions as an initial phase distribution, and
   iteratively adjusting the phase increases in the beam cross-sectional regions and calculating the intensity distribution along the optical axis setting-in in the workpiece after the raw laser beam has passed through the optical beam shaping system while taking account of linear absorption specified by the linear absorption parameter, until a two-dimensional phase distribution which compensates the linear absorption is present, by way of which the target intensity distribution along the optical axis in the workpiece arises as resultant intensity distribution; and
providing the beam shaping element with the two-dimensional phase distribution which compensates the linear absorption.

In a further aspect, this disclosure relates to a method for material processing of a workpiece using a quasi-non-diffractive laser beam, the workpiece having a material which is partly transparent to the quasi-non-diffractive laser beam and which exhibits a laser radiation intensity-independent linear absorption in relation to laser radiation in the frequency range of the quasi-non-diffractive laser beam. The method includes the steps of:
radiating a pulsed raw laser beam into an optical beam shaping system for beam shaping of the raw laser beam, with the optical beam shaping system being configured to impose a phase onto a beam cross section of the raw laser beam in such a way that laser radiation of the raw laser beam is guided to a plurality of positions in the workpiece, which are arranged along an optical axis, in an entry angle range (from for example approx. 5° to approx. 25° in the partly transparent material—correspondingly up to approx. 40° in air) with respect to the optical axis and forms the quasi-non-diffractive laser beam at the plurality of positions, with intensity losses arising on account of the linear absorption during the propagation of the laser radiation to the plurality of positions in the partly transparent material, and
setting the phase imposition in such a way that laser radiation is guided at a plurality of angles from the entry angle range to at least one position of the plurality of positions such that an intensity threshold for a nonlinear absorption, dependent on a laser radiation intensity respectively present in the partly transparent material, is exceeded at the plurality of positions in the partly transparent material despite the intensity losses arising.

In some developments of the method, the phase imposition on the beam cross section of the raw laser beam can be set in such a way that laser radiation is guided to a plurality of positions in the workpiece, which are arranged along an optical axis, in an entry angle range with respect to the optical axis comprising, in particular, entry angles ranging from for example approx. 5° to approx. 25° in the partly transparent material of the workpiece—correspondingly up to approx. 40° in air, and the said laser radiation forms the quasi-non-diffractive laser beam with the resultant intensity distribution at the plurality of positions, with intensity losses arising on account of the linear absorption during a propagation of the laser radiation to the plurality of positions in the partly transparent material. The phase imposition can be set in such a way that laser radiation is guided at a plurality of angles from the entry angle range at at least one position of the plurality of positions such that an intensity threshold for a nonlinear absorption is exceeded at the plurality of positions in the partly transparent material despite the intensity losses arising, with the nonlinear absorption in the partly transparent material depending on a respectively present intensity of the laser radiation.

In some developments of the method, laser radiation guided to the at least one position of the plurality of positions at a first angle can have a phase difference of less than pi/4 with respect to laser radiation guided to the at least one position of the plurality of positions at a second angle. Alternatively or additionally, the phase imposition can be set in such a way that the laser radiation is guided rotationally symmetrically to the plurality of positions so that each of the plurality of angles represents a local cone angle.

In some developments of the method, the setting of the phase imposition can comprise a setting of phase increases in the radial direction, which are impressed on beam cross-sectional regions of the raw laser beam, and/or a setting of geometric parameters of beam cross-sectional regions, in which one or more phase increases are impressed.

In some developments of the method, the beam cross-sectional regions can comprise at least two beam cross-sectional regions formed in ring-shaped or ring-segment-shaped fashion and the phase increases for the two beam cross-sectional regions formed in ring-shaped or ring-segment-shaped fashion are set in such a way that laser radiation from the two beam cross-sectional regions formed in ring-shaped or ring-segment-shaped fashion is fed to a joint position of the plurality of positions at two different cone angles.

In some developments of the method, there can be a setting of the intensity components of a raw laser beam intensity, which are assigned to the beam cross-sectional regions, in addition to the setting of the phase imposition in beam cross-sectional regions in order to bring about the resultant intensity distribution of the quasi-non-diffractive laser beam in the focal zone.

In some developments of the method, the phase imposition can be set for a specified transverse intensity distribution of the raw laser beam, in particular for a specified beam diameter of the raw laser beam, and a specified linear absorption of the partly transparent material of the workpiece. In the case of an unchanged phase imposition, the transverse intensity distribution, in particular a beam diameter, of the raw laser beam can be adjusted for a material with a linear absorption which deviates from the specified linear absorption of the partly transparent material, in order to increase or decrease an intensity component of a raw laser beam intensity fed to a position of the plurality of positions.

In some developments of the method, the phase imposition can be set in such a way that an intensity decrease of the quasi-non-diffractive laser beam on account of the linear absorption in the partly transparent material is compensated for in at least one portion.

In some developments of the method, the resultant intensity distribution of the quasi-non-diffractive laser beam can have an intensity distribution or an envelope intensity distribution along the optical axis which comprises deviations from an average intensity of the quasi-non-diffractive laser beam of the order of up to 10%, with the average intensity referring to the part of the focal zone in which there is a nonlinear interaction with the material of the workpiece. Optionally, the intensity distribution or the envelope intensity distribution can be substantially constant in particular.

In some developments of the method, the partly transparent material can be modified on the basis of the nonlinear absorption at a plurality of positions in the focal zone despite the intensity losses arising. The modification of the partly transparent material can extend over a length of the quasi-non-diffractive laser beam or can consist of a stringing together of modification zones along the quasi-non-diffractive laser beam.

In some developments of the method, a laser beam with a Gaussian transverse intensity profile can be used as raw laser beam and the optical beam shaping system can be configured to shape a Bessel-Gaussian beam as a quasi-non-diffractive laser beam. Additionally or alternatively, a transverse extent of the quasi-non-diffractive laser beam in the focal zone can change along the optical axis, and/or a transverse extent of the quasi-non-diffractive laser beam at a position in the focal zone can depend on angles of incidence with which laser radiation is incident on the optical axis at the position in the focal zone for the purpose of forming the quasi-non-diffractive laser beam.

In some developments, the method can further comprise the following steps:
setting beam parameters of the raw laser beam in such a way that the partly transparent material of the workpiece is modified,
positioning at least one portion of the quasi-non-diffractive laser beam in the workpiece or
bringing about a relative movement between the workpiece and the quasi-non-diffractive laser beam, in the case of which the quasi-non-diffractive laser beam is moved along a scanning trajectory in the workpiece such that strung-together modifications are written into the workpiece along the scanning trajectory.

In some developments of the method, the optical beam shaping system can comprise a diffractive optical beam shaping element and the diffractive optical beam shaping element can have mutually adjoining surface elements which construct an extensive grating structure and which are each assigned a phase shift value, with the phase shift values defining a two-dimensional phase distribution in accordance with the set phase imposition. When the raw laser beam is radiated into the optical beam shaping system, the phase imposition can be brought about by the diffractive optical beam shaping element by virtue of the phase distribution being imposed on the raw laser beam.

In general, the optical beam shaping system can comprise a beam shaping element which was formed according to the method for forming a beam shaping element disclosed herein.

In some developments of the method for forming a beam shaping element, the iteratively adjusted phase increases, in conjunction with intensity components of the raw laser beam present in the beam cross-sectional regions, can bring about a redistribution along the optical axis of the laser radiation contributing to the quasi-non-diffractive laser beam in order to form the target intensity distribution.

In some developments of the method for forming a beam shaping element, a phase increase can correspond to an angle at which laser radiation is guided with respect to the optical axis. The two-dimensional phase distribution which compensates the linear absorption can be determined iteratively in such a way that laser radiation is guided at a plurality of angles to at least one position of a plurality of positions along the optical axis.

In some developments of the method for forming a beam shaping element, the beam shaping element can have mutually adjoining surface elements which are provided with phase shift values which are set in accordance with the two-dimensional phase distribution which compensates the linear absorption. In particular, the beam shaping element can be designed as a Fresnel-axicon-like diffractive optical element, the phase shift values of which are fixedly set, or a spatial light modulator, the phase shift values of which are set in accordance with the phase distribution which compensates the linear absorption.

In some developments, the method for forming a beam shaping element can further comprise:
deriving a height profile, in particular a thickness profile of an optical material or of a mirror profile, from the two-dimensional phase distribution which compensates the linear absorption, with a local height corresponding to a local phase shift value, and
forming a refractive or reflective axicon optical unit with the height profile as the beam shaping element.

In some developments of the laser processing apparatus, the phase imposition on a beam cross section of the raw laser beam can be set in such a way using the beam shaping element that laser radiation of the raw laser beam is guided to a plurality of positions in the workpiece, which are arranged along an optical axis, in an entry angle range with respect to the optical axis and forms the quasi-non-diffractive laser beam at the plurality of positions. Intensity losses can occur on account of the linear absorption during the propagation of the laser radiation to the plurality of positions in the partly transparent material, wherein the phase imposition can be further set in such a way that laser radiation is guided at a plurality of angles from the entry angle range to at least one position of the plurality of positions such that an intensity threshold for a nonlinear absorption, dependent on a respectively present laser radiation intensity, is exceeded at the plurality of positions in the partly transparent material despite the intensity losses arising.

In some developments, the laser processing apparatus can further comprise a controller configured to set the beam adjustment optical unit in such a way that the beam diameter at the beam shaping element is larger or smaller than the specified beam diameter so as to compensate for variations in the linear absorption in relation to the linear absorption for which the phase imposition was determined.

In some developments of the laser processing apparatus, the beam shaping element can be in the form of a diffractive optical element, a spatial light modulator, or a modified refractive or reflective axicon.

In some developments of the laser processing apparatus, the phase imposition can be designed so that the resultant intensity distribution has an intensity distribution or an envelope intensity distribution which comprises deviations from an average intensity of the quasi-non-diffractive laser beam of the order of up to 10%, with the average intensity referring to a part of the focal zone in which there is a nonlinear interaction with the material of the workpiece. The intensity distribution or the envelope intensity distribution can be substantially constant in particular.

The concepts disclosed herein relate to the approach of a quasi-non-diffractive laser beam formed by means of an optical beam shaping system being able to have an intensity distribution in the focal zone which varies (i.e., is variably formed/set) in the longitudinal direction (usually in the beam propagation direction) when an elongate focal zone is formed in air, with the result that, when this quasi-non-diffractive laser beam is radiated into a workpiece to be processed, a resultant intensity distribution within the workpiece is preferably approximately constant. In particular, the profile of the variable intensity distribution in air is adapted to the linear absorption behavior of the material of the workpiece. In this case, the resultant intensity distribution should be understood to mean the intensity distribution present in the partly transparent material, whereas the aforementioned variable intensity distribution is present when there is no interaction with the linearly absorbing material of the workpiece (i.e., for example in air). For material processing, an approximately constant intensity distribution in the material for example comprises deviations from an average intensity of the laser beam of the order of, for example, up to 10%, with the average intensity referring to the part of the focal zone in which the (nonlinear) interaction with the material of the workpiece occurs.

A person skilled in the art will acknowledge that a phase imposition carried out according to embodiments of the invention can be implemented by means of a refractive, diffractive, and/or reflective beam shaping system. In addition to the phase imposition, provision can further be made for an amplitude to be imposed on the raw laser beam by means of the beam shaping system.

The concepts disclosed herein relate in particular to beam shaping, which causes beam components to enter at an entry angle with respect to a beam axis of the laser beam for the formation of an elongate focal zone by way of interference of the beam components. During the material processing, the beam components enter in part through the material of the workpiece. In particular portions of the elongate focal zone which are downstream in the beam path are consequently based on laser radiation which propagates through the material along an optical path, the length of which is of the order of the length of the focal zone.

Further, the beam shaping described herein concerns beam shaping which produces a quasi-non-diffractive beam for forming the elongate focal zone along the beam axis in the partly transparent workpiece. The linear absorption may affect the intensity distribution along the focal zone, especially in the case of such focal zones which extend over a significant length of up to a few millimeters in the propagation direction. A (longitudinal) intensity distribution along the elongate focal zone considered in this context is characterized by the profile of a maximum of the intensity in the propagation direction. In some embodiments, the profile of a quasi-non-diffractive beam may have a plurality of local intensity maxima along the elongate focal zone, with the result that a function which envelops the local intensity maxima can be used for the (longitudinal) intensity distribution (envelope intensity distribution) in these embodiments. Further, a transverse intensity distribution of the quasi-non-diffractive beam can be considered at each position in the propagation direction, especially at each local intensity maximum.

With regard to laser processing, an elongate focal zone is the term used if a three-dimensional intensity distribution with respect to a target threshold intensity is characterized by an aspect ratio (as ratio of the extent of the quasi-non-diffractive beam in the propagation direction to the lateral extent transversely to the quasi-non-diffractive beam (diameter of the intensity maximum)) of at least 10:1, for example 20:1 or more, or 30:1 or more, or 1000:1 or more. In the case of a modulated intensity distribution, the aspect ratio can be related to the aforementioned enveloping function of the intensity distribution.

In the case of a correspondingly sufficient intensity, a quasi-non-diffractive beam may lead in the elongate focal zone to a modification in the material with a similar aspect ratio or to an arrangement of a plurality of modification zones, which are delimited by an envelope with a corresponding aspect ratio. The modification/the arrangement of a plurality of modification zones may preferably extend over a length of the quasi-non-diffractive laser beam (5).

In general, for the quasi-non-diffractive beams with such aspect ratios disclosed herein, a maximum change in the transverse extent of the intensity distribution over the focal zone in the material may be of the order of 50% and less, for example 20% and less, for example of the order of 10% and less, in relation to an average transverse extent, with the average transverse extent relating to the part of the focal zone in which the (nonlinear) interaction with the material of the workpiece occurs. The same applies, mutatis mutandis, to a maximum change in the transverse/lateral extent of the modification.

The concepts described herein are provided for the production of elongate focal zones and accordingly elongate modifications with high aspect ratios, even in partly transparent materials.

The aspects disclosed herein relate in particular to laser-based material processing of a partly transparent workpiece, the linear absorption of which is given by an absorption coefficient ranging from approx. 0.1/mm to approx. 2.5/mm.

The aspects described herein relate in particular to the application of non-diffractive beams during material processing. Non-diffractive beams—alternatively also referred to as “propagation invariant beams”—can be formed by wave fields which satisfy the Helmholtz equation

∇²U(r)+k²U(r)=0 (Equation 1)

and have a clear separability into a transverse (i.e., in the x- and y-directions) dependence and a longitudinal dependence (i.e., a dependence in the z-direction/propagation direction) of the form

U(x,y,z)=U^{t}(x,y)exp(ιk_{z}z) (Equation 2)

In this case, k=ω/c is the wave vector with its longitudinal/axial and transverse components k²=k_{z}²+kₜ² and U^{t}(x,y) is an arbitrary complex-valued function which is dependent only on the transverse coordinates x and y. Since the z-dependence in equation 2 has a pure phase modulation, an intensity I(x,y,z) of a function that solves the equation 2 is propagation-invariant and is referred to as “non-diffractive”:

I(x,y,z)=|U(x,y,z)|²=I(x,y,0) (Equation 3)

This approach provides different classes of solutions to the Helmholtz equation in different coordinate systems, for example so-called Mathieu beams in elliptic-cylindrical coordinates or so-called Bessel beams in circular-cylindrical coordinates.

In this respect, see also J. Turunen and A. T. Friberg, “Propagation-invariant optical fields”, in Progress in optics, 54, 1-88, Elsevier (2010) and M. Woerdemann, “Structured Light Fields: Applications in Optical Trapping, Manipulation, and Organisation”, Springer Science & Business Media (2012).

A large number of types of non-diffractive beams can be realized to a good approximation. These implemented non-diffractive beams are referred to herein as “quasi-non-diffractive beams” or “spatially restricted non-diffractive” beams or else, for simplicity, still as “non-diffractive beams”. Quasi-non-diffractive beams, which is to say non-diffractive laser beams shaped by optical means/optically implemented non-diffractive laser beams, have a finite power in contrast with the theoretical construct. A length L of a propagation invariance that is assigned to them is also likewise finite.

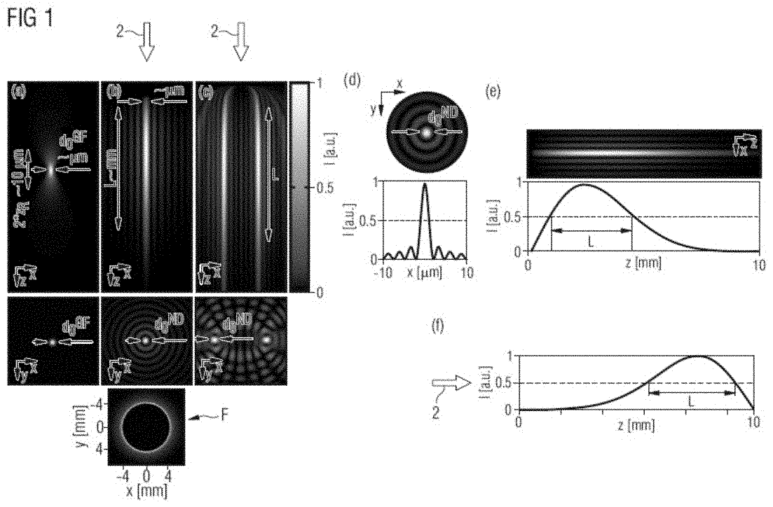

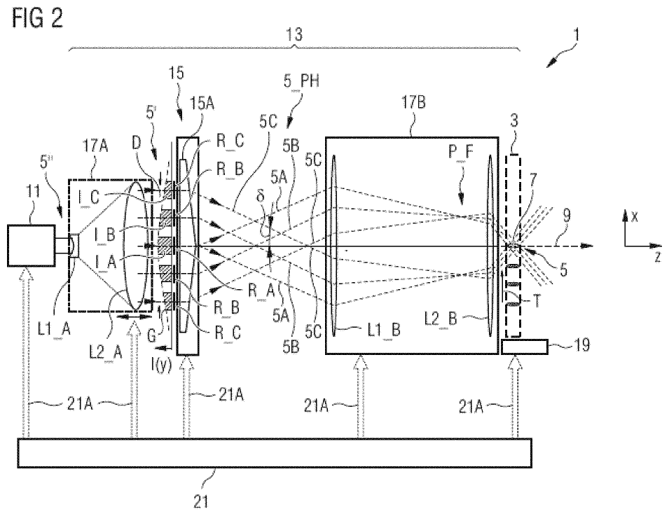

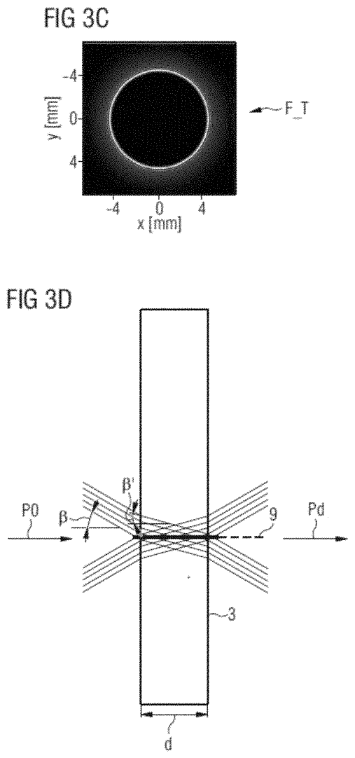

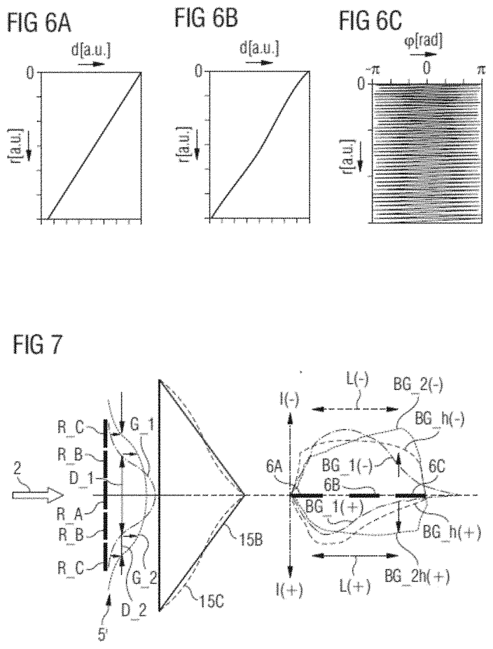

FIG. 1 shows, in comparison with intensity representations of a conventional Gaussian focus (see the propagation behavior of a Gaussian focus in subfigure (a) in FIG. 1), the propagation behavior of quasi-non-diffractive beams on the basis of intensity representations in subfigures (b) and (c). Subfigures (a), (b), and (c) each show a longitudinal section (x-z-plane) and a transverse section (x-y-plane) through the focus of a Gaussian beam or quasi-non-diffractive beams, which propagate in the z-direction, with arrows 2 additionally elucidating the propagation direction in the z-direction (e.g., likewise in FIGS. 4 and 7). Subfigure (b) also shows a transverse far-field distribution F of the quasi-non-diffractive beam. See FIG. 2 in relation to the position of the far-field distribution. If a quasi-non-diffractive beam is produced using an axicon, the only spatial frequency produced in the far field can be traced back to the (defined) cone angle of the axicon.

The subfigure (b) relates by way of example to a rotationally symmetrical quasi-non-diffractive beam, here a Bessel-Gaussian beam. The subfigure (c) relates by way of example to an asymmetrical quasi-non-diffractive beam. For a Bessel-Gaussian beam, the subfigures (d) and (e) in FIG. 1 further show details of a central intensity maximum. In this regard, subfigure (d) in FIG. 1 shows an intensity profile in a transverse sectional plane (x-y-plane) and a transverse intensity profile in the x-direction. The subfigure (e) in FIG. 1 shows details of the central intensity maximum in a section in the propagation direction (z-direction).

A focus diameter d₀^{GF} of the Gaussian focus is defined for the comparison of the quasi-non-diffractive beam with a Gaussian beam, the Gaussian focus being defined by way of the second moments. Furthermore, an associated characteristic length of the Gaussian beam is defined by way of the Rayleigh length z_{R}=π(d₀^{GF})²/4λ, which is defined as a distance proceeding from the focus position at which the beam cross section has increased by a factor of 2. Furthermore, for a quasi-non-diffractive beam, a transverse focus diameter d₀^{ND} is defined as the transverse dimension of a local intensity maximum, the transverse focus diameter d₀^{ND} being given by the shortest distance between directly adjacent, opposite intensity minima (e.g., intensity decrease to 25%). In this respect, see e.g. the subfigures (b) and (d) in FIG. 1. The longitudinal extent (axial extent, present in the propagation direction) of the almost propagation-invariant intensity maximum can be regarded as a characteristic length L of the quasi-non-diffractive beam. It is defined by way of an intensity decrease to 50%, proceeding from the local intensity maximum, in each case in the positive and negative z-direction; see subfigures (c) and (e) in FIG. 1.

A quasi-non-diffractive beam is assumed herein if, for similar transverse dimensions, for example d₀^{ND}≈d₀^{GF}, the characteristic length L of the quasi-non-diffractive beam distinctly surpasses the Rayleigh length of the associated Gaussian focus, particularly if L>10z_{R}.

(Quasi-)Bessel beams, also known as Bessel-like beams, are examples of a class of (quasi-)non-diffractive/propagation invariant beams. In the case of such beams, the transverse field distribution U^{t} (x,y) in the vicinity of the optical axis obeys to a good approximation a Bessel function of the first kind of order n. A subset of this class of beams are the so-called Bessel-Gaussian beams, which are widely used owing to the simple generability thereof. A Bessel-Gaussian beam can be shaped for example by illuminating an axicon of refractive, diffractive or reflective embodiment with a collimated Gaussian beam. In this case, an associated transverse field distribution in the vicinity of the optical axis in the region of an associated elongate focal zone obeys to a good approximation a Bessel function of the first kind of the order 0, which is enveloped by a Gaussian distribution; see subfigure (d) in FIG. 1.

Typical Bessel-Gaussian beams which can be used for the processing of transparent materials have diameters of the central intensity maximum on the optical axis of the order of d₀^{ND}=2.5 μm. The associated length L of a quasi-non-diffractive beam can readily exceed 1 mm; see subfigure (b) in FIG. 1. By contrast, a focus of a Gaussian beam where d₀^{GF}≈d₀^{ND}=2.5 μm is distinguished by a focal length in air of just z_{R}≈5 μm at a wavelength λ of 1 μm; see subfigure (a) in FIG. 1. In these cases that are relevant to material processing, the following accordingly even holds true for the associated length L: L>>10z_{R}, for example 100 or more times or even 1000 or more times the Rayleigh length.

Subfigure (f) in FIG. 1 shows an inverse Bessel-Gaussian beam as an example for a further quasi-non-diffractive beam. It is evident how imaging a virtual Bessel-Gaussian beam (see the publications cited at the outset) inverts the longitudinal intensity distribution of the inverse Bessel-Gaussian beam in comparison with the Bessel-Gaussian beam in relation to the propagation direction.

Aspects described herein are based in part on the discovery that if a workpiece made of a partly transparent material is intended to be processed using a quasi-non-diffractive beam, then the linear absorption affects the intensity present along the quasi-non-diffractive beam, which is to say in the elongate focal zone. This is especially the case if the quasi-non-diffractive beam is formed for example in an interference-based focal zone of a Bessel-Gaussian beam. Accordingly, beam shaping as used for processing substantially transparent workpieces is no longer productive since the processing along the quasi-non-diffractive beam produced thus would be carried out under different interaction conditions (on account of the reducing intensity in the propagation direction) or would spatially no longer occur to the required extent.

In order to obtain the formation and properties of the quasi-non-diffractive beam, for example with a Bessel beam-like beam profile, in the partly transparent workpiece, the absorbing effect that occurs when passing through the workpiece is proposed to be counteracted herein by an “increased introduction of intensity along the focal zone”. Accordingly, a quasi-non-diffractive beam is formed—when the linear absorption is neglected—with an intensity distribution that increases along the propagation direction, for example as would form in the case of a comparison workpiece without linear absorption or in air, for example. The increase in the intensity distribution (without linear absorption in the workpiece) can then in at least one portion compensate the decrease in the intensity on account of the linear absorption.

An increasing intensity distribution (without linear absorption in the workpiece) can be implemented firstly by a specific adjustment to the phase imposition (for example brought about by a specific shaping of the geometry of the axicon or a specifically designed phase distribution of a diffractive optical element).

Secondly, use can be made of known phase impositions with modified beam parameters. For example, a phase imposition/beam shaping optical unit can be designed so that it brings about an intensity distribution which is homogenized in the propagation direction for a specified beam diameter when linear absorption in the workpiece is neglected, by virtue of distributing laser power uniformly along the focal zone, in particular by virtue of redistributing intensity in downstream portions of the quasi-non-diffractive beam. A homogenized Bessel-Gaussian beam is one example. In an embodiment of the invention, it is now possible to use such a phase imposition/beam shaping optical unit with a varied beam diameter, for example with an increased beam diameter, with the beam diameter being chosen so that more intensity is redistributed into downstream portions of the quasi-non-diffractive beam in order thus to counteract the linear absorption.

Thus, it was recognized that an influence of the intensity distribution along the propagation direction of a quasi-non-diffractive beam can be counteracted in at least one portion by way of linear absorption during the propagation in the workpiece. Moreover, it was recognized that, in the case of appropriate measures being taken, beam shaping concepts and beam shaping component parts developed for substantially transparent workpieces can be used to form a quasi-non-diffractive beam in an absorbing material.

Thus, despite linear absorption during the propagation of laser radiation in a partly transparent workpiece, it was recognized that a quasi-non-diffractive beam with a substantially unchanging intensity distribution in the propagation direction can be produced in the material of the workpiece. Accordingly, elongate modifications can also be written into a workpiece with partial transparency. Structural modifications produced in this way can for example enable a separating process or be used for material ablation, as in the case of substantially transparent workpieces.

FIG. 2 shows a schematic illustration of a laser processing apparatus 1 for processing a workpiece 3 using a quasi-non-diffractive (laser) beam 5. The concepts disclosed herein are directed specifically to the processing of workpieces from a material which is partly transparent to the laser beam 5 and which accordingly causes linear absorption of the laser beam 5. For example, the workpiece 3 can be a partly transparent (e.g., stained) glass, for example a glass sheet, or an object that is partly transparent to the laser wavelength used, for example a sheet with a ceramic or crystalline embodiment (for example made of aluminum oxide or zirconium oxide such as sapphire, for example a natural or artificially stained sapphire). For example, in the spectral range of the laser beam 5, the material absorbs 50% of the intensity of passing laser radiation over a length of 1 mm. In general, the material of the workpiece may have absorption coefficients ranging from approx. 0.1/mm to approx. 2.5/mm, with corresponding transmissions ranging from 90% to 10% per millimeter of material thickness, for example precisely 50% per 1 mm glass thickness.

Processing with the quasi-non-diffractive laser beam brings about a modification of the material of the workpiece 3 in a focal zone 7 formed by the quasi-non-diffractive laser beam 5. As is indicated in FIG. 2, the focal zone 7 has a generally elongate form in a propagation direction (direction of propagation; z-direction here) of the quasi-non-diffractive laser beam 5. For example, the focal zone 7 can be formed as a focal zone of a Bessel-Gaussian beam or an inverse Bessel-Gaussian beam.

The laser processing apparatus 1 comprises a laser beam source 11 (for example, an ultrashort pulse high-power laser system), which produces and emits a laser beam 5″. The laser beam 5″ is for example pulsed laser radiation. For material processing, laser pulses of the pulsed laser radiation have for example pulse energies which lead to peak pulse intensities in the quasi-non-diffractive beam that cause a nonlinear absorption in the material of the workpiece 3 and hence a formation of a modification in a geometry specified by the intensity profile of the quasi-non-diffractive beam.

For the purpose of guidance and beam shaping, the laser processing apparatus 1 also comprises an optical beam shaping system 13. The optical beam shaping system 13 can be provided, at least in part, in a processing head which is part of the laser processing apparatus 1 and which can be arranged spatially relative to the workpiece 3.

The optical beam shaping system 13 comprises a beam shaping optical unit 15 for the phase imposition on a raw laser beam 5′. In FIG. 2, the laser radiation emerging from the beam shaping optical unit 15 represents phase-imposed laser radiation 5_PH, which is used to shape the quasi-non-diffractive beam 5. Beam components 5A, 5B, and 5C of the phase-imposed laser radiation 5_PH are indicated in exemplary fashion. Diffractive optical beam shaping elements and refractive or reflective optical unit implementations can be used as beam shaping optical unit, with these being able to be embodied herein as substantially equivalent optical means in respect of a transverse phase imposition to be undertaken.

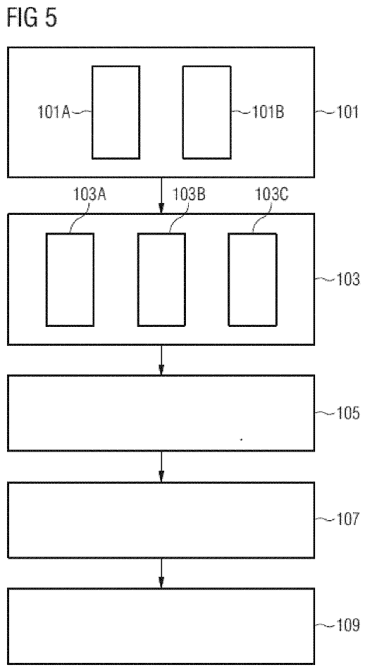

The beam shaping optical unit 15 is for example an axicon, a hollow cone axicon, a (hollow cone) axicon lens/mirror system, a reflective axicon lens/mirror system, with these component parts having been modified in terms of their phase-imposing property in relation to a linear absorption present in a workpiece in order to produce a formation of increasing intensity distributions in comparison materials without linear absorption (see FIG. 6B). Modified geometries of an axicon or inverse axicon deviate from the linear dependence of the thickness of the conventional conical axicon on a radial distance from the beam axis.

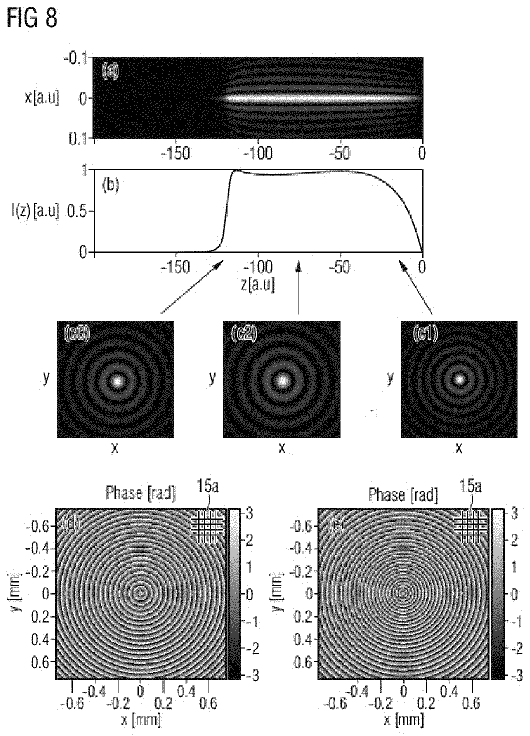

Further, the beam shaping optical unit 15 can be a programmable or permanently written diffractive optical beam shaping element, in particular a spatial light modulator (SLM). For example, a diffractive optical beam shaping element comprises mutually adjoining surface elements (see also FIG. 8, subfigures (d1) and (d2)) which construct an extensive grating structure, in which each surface element is assigned a phase shift value. With the aid of specifically chosen phase shift values it is possible, for example, to reproduce a geometry of a (hollow cone) axicon, with the phase imposition likewise being able to be modified in relation to the implementation of a conventional axicon. Reference is made to the publications cited at the outset in respect of exemplary configurations of the optical beam shaping system 13 and, in particular, the beam shaping optical unit 15. These further disclose that quasi-homogenized intensity distributions in the axial direction in elongate focal zones of Bessel-Gaussian beams can be produced as an example of a quasi-non-diffractive beam in a transparent material. In this case, the homogeneity in the intensity may be present continuously along the elongate focal zone or there may be a sequence of intensity maxima, for example with comparable intensity values, present along the focal zone.

The beam shaping optical unit 15 can be configured to bring about an entry of beam components of a raw laser beam 5′, which can be traced back to the laser beam 5″, at an entry angle δ′ with respect to a beam axis 9 for the purpose of forming the quasi-non-diffractive laser beam 5 along the beam axis 9 in the workpiece 3 by way of interference of the beam components. For workpieces made of a partly transparent material, the entry angle δ′ is located within an entry angle range of for example approx. 5° to approx. 250 with respect to the beam axis 9 in the partly transparent material (correspondingly up to approx. 400 in air). For elongate material processing, comparable intensities causing nonlinear absorption in the partly transparent material are preferably present in at least a plurality of portions of the quasi-non-diffractive laser beam 5. To this end, specially adjusted entry angles δ′, for example, can be provided (see also FIG. 6B), and these bring about a reordering of intensity components in the propagation direction for the purpose of adjusting the intensity along the focal zone/quasi-non-diffractive beam.

Optionally, the optical beam shaping system 13 comprises a beam adjustment optical unit 17A, for example in the form of a first telescope (represented schematically in FIG. 2 on the basis of lenses L1_A and L2_A). The beam adjustment optical unit 17A is configured to adjust a beam diameter of the laser beam 5″ and to feed the laser beam 5″ to the beam shaping optical unit 15 as a raw laser beam 5′ with a raw laser beam diameter D.

FIG. 2 schematically indicates a Gaussian intensity distribution G with beam diameter D in an intensity diagram I(y) for the raw laser beam 5′. By varying the spacing of the lenses L1_A and L2_A, it is possible to use the beam adjustment optical unit 17A for adjusting the beam dimension at the beam shaping optical unit 15.

FIG. 2 depicts beam shaping with an axicon-like phase imposition in exemplary fashion with beam paths for different beam cross-sectional regions of the raw laser beam 5′ (e.g., corresponding to intensity rings in the intensity diagram I(y)). FIG. 2 schematically indicates an axicon cross section 15A in exemplary fashion. In the case of an axicon-like phase imposition, the laser radiation is rotationally symmetrically guided at positions along the optical axis 9, with each entry angle representing a local cone angle which has an effect on an intensity ring in the intensity diagram I(y).

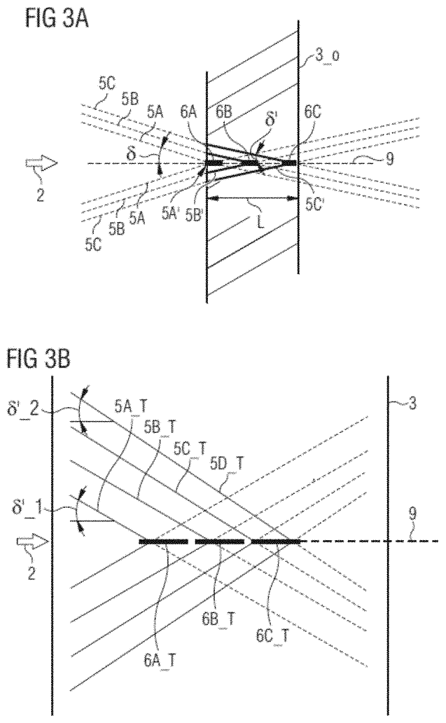

The formation of a quasi-non-diffractive beam 5 is represented in enlarged fashion in FIG. 3A (for a fixed entry angle) and in FIG. 3B (for entry angles set variably within an entry angle range).

In a z-y-sectional plane along the beam axis 9, depicted in FIG. 3A, an exemplary beam path for a Bessel-Gaussian beam—as may be used, for example, in the absence of linear absorption, which is to say for processing a transparent workpiece 3_o—is elucidated on the basis of schematic beam components for the formation of a quasi-non-diffractive beam. Indicated once again are (radial) beam components 5A, 5B, 5C, which enter at an entry angle δ in air or δ′ in the material (specified by the cone angle of the axicon) with respect to the beam axis 9 of the laser beam 5.

In this case, laser radiation of the beam component 5A, which is assigned to a (radially interior) beam cross-sectional region R_A of the raw laser beam 5′ about the beam center, forms a first portion 6A of the quasi-non-diffractive laser beam. Laser radiation of the beam component 5B, which is assigned to a central ring-shaped beam cross-sectional region R_B of the raw laser beam 5′, forms a central portion 6B of the quasi-non-diffractive laser beam. Laser radiation of the beam component 5C, which is assigned to an outer ring-shaped beam cross-sectional region R_C of the raw laser beam 5′, forms a final portion 6C of the quasi-non-diffractive laser beam.

The quasi-non-diffractive beam forms along the beam axis 9 in the transparent workpiece 3_o as a result of interference of the beam components 5A, 5B, 5C (over a length L; see also FIG. 1). It is evident that the beam components 5B, 5C further to the outside traverse a longer path in the material and would consequently—in the case of a partly transparent material—be exposed to stronger linear absorption than the beam component 5A further to the inside. Accordingly, if a conventional axicon (with a fixedly set cone angle) is used for the beam shaping, then the intensities present in the focal zone at the portions 6A, 6B, 6C of the quasi-non-diffractive beam are affected by linear absorption to a different extent.

Returning to FIG. 2, optical paths of the laser radiation of the beam components 5A, 5B, 5C are indicated schematically from the beam shaping element 15 to the focal zone 7. Essential to the linear absorption is the component of the optical paths in the partly transparent material of the workpiece 3. In FIG. 3A, these components of the optical paths are provided with the reference signs 5A′, 5B′, and 5C′ for the laser radiation of the beam components 5A, 5B, 5C.

As is further evident from FIG. 2, an intensity component I_A, I_B, I_C of the intensity of the raw laser beam 5′ is assigned to each of the beam cross-sectional regions R_A, R_B, R_C. A person skilled in the art will acknowledge that the assignments of beam cross-sectional region, intensity component, and portion of the quasi-non-diffractive laser beam are represented in simplified fashion in FIG. 2 and FIG. 3A.

Variations in the entry angle δ′ can now be set by adjusting the phase imposition for the material processing of a workpiece made of a partly transparent material. This is depicted schematically in FIG. 3B for the partly transparent workpiece 3.

For example, the phase imposition is set so that laser radiation varies along the quasi-non-diffractive laser beam in terms of its entry angle with respect to the beam axis 9 or is formed by laser radiation from a plurality of entry angles at a position/portion of the quasi-non-diffractive laser beam. By way of example, in FIG. 3B, laser radiation 5B_T is incident at a flatter angle than laser radiation 5A_T; laser radiation 5C_T is incident at a steeper angle than the laser radiation 5B_T; laser radiation 5D_T is incident at an even steeper angle than the laser radiation 5C_T. In the case of an appropriate choice of the entry angles for the various beam components, it is possible to adapt to the differently strong influences of the linear absorption the intensity of the laser radiation which is guided at the various portions 6A_T, 6B_T, 6C_T along the optical axis 9 for the purpose of constructively interfering there and forming the quasi-non-diffractive laser beam.

If FIGS. 3A and 3B are considered as a beam-optical comparison, then a (quasi-)non-diffractive laser beam is produced in FIG. 3A by feeding the radiation components (field components) with a global (globally non-varying) cone angle with a resultant fixed entry angle δ′ (usually in the transparent material). In FIG. 3B, a (quasi-)non-diffractive laser beam is produced by a plurality of specifically set local cone angles with resultant varying entry angles δ′_1, δ′_2. It is observed that, for clarity, laser radiation 5C_T and laser radiation 5D_T for example are incident on the optical axis 9 next to one another in FIG. 3B. Depending on the position of the contributing beam cross-sectional regions and the assigned phase increases (entry angles), laser radiation will be guided to a position on the optical axis 9 at a plurality of angles (from an entry angle range assigned to the beam shaping element 15). The respective phase difference present on account of the different phases in the focal zone 7 accumulated along the various optical paths is included in a (constructive/destructive) superposition of the laser radiation at a plurality of angles.

FIG. 3C also shows a transverse far-field distribution F_T, as may be present when producing a quasi-non-diffractive laser beam which is homogenized in a partly transparent material. See FIG. 2 in relation to the position of the far-field distribution F_T. The far-field distribution F_T shows a spatial frequency spectrum having a plurality of frequencies (corresponding to the angles δ′_1, δ′_2), on the basis of the spatial interferences. In comparison with the production of a quasi-non-diffractive laser beam which is homogenized in a transparent material, the weighting of intensities of the spatial frequencies is adapted to the linear absorption behavior for the purpose of producing the quasi-non-diffractive laser beam which is homogenized in the partly transparent material.

With reference to FIG. 2, the optical beam shaping system 13 further comprises an imaging system 17B, for example embodied in the form of a second telescope (depicted schematically on the basis of lenses L1_B, L2_B in FIG. 2) for imaging a real or virtual beam profile into the partly transparent workpiece 3. The imaging system 17B can also be used to set the length of the quasi-non-diffractive beam in the workpiece 3, for example by changing the focal length of the imaging system 17B. A person skilled in the art will acknowledge that the lens L1_B may also be combined with the beam shaping element 15, like in the publications cited at the outset.

Further, a far-field distribution of the quasi-non-diffractive laser beam forms in the imaging system 17B (for example the far-field distribution F in FIG. 1, subfigure (b) or the far-field distribution F_T in FIG. 3C). The position P_F of the far field is indicated schematically in FIG. 2 by an intermediate focus between the lenses L1_B and L2_B.

The optical beam shaping system 13 may comprise further beam-guiding component parts, for example deflection mirrors and filters, and control modules for aligning and adjusting the various component parts.

The laser processing apparatus 1 further comprises a workpiece mount 19, indicated schematically in FIG. 2, for mounting and optionally moving the workpiece 3.

For the processing of the workpiece 3, a relative movement is performed between the optical beam shaping system 13 (the quasi-non-diffractive laser beam) and the workpiece 3, with the result that the quasi-non-diffractive beam 5/focal zone 7 can be formed at various positions along a predetermined (processing) trajectory T in the workpiece 3. Preferably, the quasi-non-diffractive laser beam 5 can be moved along the scanning trajectory such that strung-together modifications are written into the workpiece along the scanning trajectory T. For separating the workpiece 3 into two parts for example, the trajectory T then determines the profile of a subsequent separating line.

The laser processing apparatus 1 furthermore has a controller 21, which has in particular an interface for the inputting of operating parameters by a user. In general, the controller 21 comprises electronic control components such as a processor for controlling electrical, mechanical, and optical component parts of the laser processing apparatus 1. By way of example, operating parameters of the laser beam source 11 such as, for example, pump laser power, pulse duration, and pulse energy, parameters for the setting of an optical element (for example of an SLM), and parameters for the spatial alignment of an optical element of the optical beam shaping system 13 and/or parameters of the workpiece mount 19 (for traversing the scanning trajectory T) can be set. In FIG. 2, the functional connection of the controller 21 to the various controllable component parts is indicated by dashed connections 21A.

In general, the controller 21 may be configured to set the phase imposition in such a way that a resultant intensity distribution of the quasi-non-diffractive laser beam 5 in the focal zone is at least approximately constant in the longitudinal direction z when radiating into the partly transparent material of the workpiece, which is to say when focusing the phase-imposed laser radiation into the partly transparent material of the workpiece. For example, the controller 21 thus can be configured to set the phase distribution of an adjustable diffractive optical element (SLM).

Alternatively or additionally, the controller 21 may for example be configured to set a dimension of at least one of the beam cross-sectional regions R_A, R_B, R_C and/or at least one of the intensity components I_A, I_B, I_C. In particular, the adjustment may be implemented in such a way that a plurality of the intensity components of the radiation take account of an intensity loss which occurs on account of the linear absorption along an optical path from the respective beam cross-sectional region to the associated portion 6A_T, 6B_T, 6C_T of the quasi-non-diffractive laser beam. Using beam parameters set thus, it is possible to modify the material in the associated portions 6A_T, 6B_T, 6C_T of the quasi-non-diffractive laser beam on the basis of a nonlinear absorption which depends on the intensity of the quasi-non-diffractive laser beam in the respective portion. By way of example, the controller 21 can control the telescope arrangement 13A to bring about an increase or reduction in the beam diameter D of the raw laser beam 5′ at the beam shaping optical unit 15 for the purpose of setting the sizes of the intensity components I_A, I_B, I_C (and/or of the beam cross-sectional regions R_A, R_B, R_C).

For a material with a linear absorption that deviates from a linear absorption of the partly transparent material for which a phase imposition was designed, the controller 21 can for example alternatively or additionally be configured to adjust the transverse intensity distribution of the raw laser beam while leaving the phase imposition unchanged in order to increase or reduce an intensity component of a raw laser beam intensity fed to a position of the plurality of positions and thereby compensate for the deviation in the linear absorption.

In general, the laser radiation used for the material processing, which is to say the laser beam 5″, the raw laser beam 5′, and the laser beam 5, is determined by beam parameters such as wavelength, spectral width, temporal pulse shape, formation of pulse groups, beam diameter, transverse intensity profile, transverse input phase profile, input divergence, and/or polarization.

Exemplary parameters of the laser radiation which can be used within the scope of this disclosure are the following:
laser pulse energies/energy of a laser pulse group (burst): for example in the mJ range or more, for example in the range of between 20 μJ and 5 mJ (e.g., 1200 μJ), typically between 100 μJ and 1 mJ
wavelength ranges: IR, VIS, UV (for example 2 μm >λ>200 nm; for example 1550 nm, 1064 nm, 1030 nm, 515 nm, 343 nm)
pulse duration (FWHM): a few picoseconds (for example 3 ps) or shorter, for example a few hundred or a few (tens of) femtoseconds
number of laser pulses in a burst: e.g. 2 to 4 pulses (or more) per burst with a temporal spacing in the burst of a few nanoseconds
number of laser pulses per modification: one laser pulse or a burst for one modification
repetition rate: usually greater than 0.1 kHz, for example 10 kHz
length of the focal zone in the material: greater than 20 μm, up to a few millimeters
diameter of the focal zone in the material: greater than 1 μm, up to 20 μm or more
(resulting lateral extent of the modification in the material: greater than 100 nm, for example 300 nm or 1 μm, up to 20 μm or more)
advancement d between two adjacent modifications: at least the lateral extent of the modification in the advancing direction (usually at least double the extent, for example four times the extent)

The pulse duration here relates to an individual laser pulse. Accordingly, an exposure time relates to a group/burst of laser pulses which result in the formation of a single modification at one location in the material of the workpiece. If the exposure time, like the pulse duration, is short with respect to an advancing rate present, one laser pulse and all of the laser pulses of a group of laser pulses contribute to a single modification at one location. Continuous modification zones comprising modifications adjoining one another and merging into one another may also arise at a relatively low advancing rate.

The abovementioned parameter ranges may allow the material processing with quasi-non-diffractive beams which project up to, for example, 20 mm or more (typically 100 μm to 10 mm) into a partly transparent workpiece.

According to FIG. 2, the laser beam 5″ is fed to the optical beam shaping system 13 for the purpose of beam shaping, which is to say converting one or more of the beam parameters. Usually, the laser beam 5″, and accordingly the raw laser beam 5′, will to a good approximation be a collimated Gaussian beam with a transverse Gaussian intensity profile.

An optical axis 9 which preferably runs through a point of symmetry of the beam shaping optical unit 15 (e.g., through a beam center position of an axicon (axicon tip) or a diffractive optical beam shaping element) can be assigned to the propagation of the laser radiation and, in particular, to the optical beam shaping system 13. The laser radiation propagates along the optical axis 9. In the case of a rotationally symmetric laser beam 5″, an intensity maximum of a transverse beam profile of the laser beam 5″ (Gaussian intensity distribution G in FIG. 2) may be incident along the optical axis 9 of the optical beam shaping system 13. A correspondingly large region of the beam shaping optical unit 15 is illuminated depending on the diameter D of the intensity distribution G.

The optical beam shaping system 13 shapes the quasi-non-diffractive laser beam 5, which forms the focal zone 7, from the raw laser beam 5′. For example, a Bessel-Gaussian beam with a conventional or inverse Bessel beam-like beam profile can be produced with the aid of the beam shaping optical unit 15.

It is generally true for the processing of partly transparent materials by means of nonlinear absorption that, as soon as a nonlinear absorption takes place, this absorption itself, or else the resultant changing of the material property, can influence the propagation of laser radiation. In the case of quasi-non-diffractive beams, the beam components serving modification purposes further downstream can be fed to the interaction zone at an adjusted entry angle with respect to the focal zone axis such that upstream regions of the quasi-non-diffractive beam are not irradiated. An example for such supply of energy is the Bessel-Gaussian beam, in the case of which there is a ring-shaped far-field distribution, the ring width of which is typically small in comparison with the radius (see subfigure (b) in FIG. 1). In the case of a rotationally symmetric Bessel-Gaussian beam, radial beam components are fed rotationally symmetrically to the interaction zone/focal zone axis substantially at this predetermined angle. This is similarly true for the inverse Bessel-Gaussian beam and for modifications such as homogenized, asymmetrical or modulated (inverse) Bessel beams.

Even if regions of nonlinear absorption can be avoided when feeding laser radiation to downstream portions, the linear absorption of the partly transparent workpiece has an effect on the laser radiation which forms downstream portions of the quasi-non-diffractive beam.

A consideration of the effect of the absorbing material property of a partly transparent workpiece 3 is summarized with reference to FIGS. 3D to 3F. An entrance of the (radial) beam components at an entry angle R in air or an entry angle (cone angle) β′ in the material with respect to the optical axis 9 of the laser beam is evident. In the case of a refractive index n of the workpiece, the entry angle β′ is given by β′=sin⁻¹[sin(β)/n]. The quasi-non-linear beam can form in the workpiece 3 along the beam axis 9 by interference of the entering beam components over an entire thickness d of the partly transparent workpiece 3.

The linear absorption can be described by the “optical depth”, in accordance with τ=−ln(P_{d}/P₀). From this, the absorption coefficient α arises as: α=τ/d.

The linear absorption occurs along the optical paths up to positions x (in the context of FIGS. 3D to 3F, the laser radiation propagates in the x-direction) on the optical axis 9. The associated path lengths are given by x′=x/cps(β′). With a modified absorption coefficient

$${α}^{′} = \frac{ln ( {P}_{d} / {P}_{0} )}{cos ( {β}^{′} ) d} ,$$

the power reduction along the optical paths emerges as P(x′)=P₀ exp(−α′x′). The power reduction (damping behavior in the material) along the optical axis arises as P(x)=P₀ exp(−αx).

For example, FIG. 3E shows the damping behavior for a partly transparent material of thickness d=1 mm and with a refractive index of n=1.45 in the case of a cone angle of the phase-imposed radiation of β=20°. This yields a modified absorption coefficient α′ of 0.71 under the assumption that 50% of the power is linearly absorbed in the material (P0=1 on the entrance side, Pd=0.5 on the exit side).

FIG. 3E shows the exponential drop in power P(x). To compensate the damping behavior in the material, inverting P(x) yields the required compensation Pₖ=exp(α′x). FIG. 3F shows the compensation function Pk(x) for the above values discussed in exemplary fashion. The profile of the compensation function in the partly transparent material corresponds to the required intensity profile on the optical axis 9 of the non-diffractive beam for the case where no linear absorption is present.

Expressed differently, the formation of a comparable intensity in portions 6A_T, 6B_T, 6C_T in FIG. 3B assumes that the contributing components of the laser radiation 5A_T, 5B_T, 5C_T, 5D_T introduce a comparable intensity input into the corresponding portions of the quasi-non-diffractive beam. That is to say, the intensity components I_A, I_B, I_C of the intensity of the raw laser beam 5′ for the different portions 6A_T, 6B_T, 6C_T should be comparable if a comparable nonlinear absorption (for comparable interaction with the material) should occur in each of the portions.

FIG. 4 elucidates the effect of the linear absorption if a homogenized Bessel beam produced using a beam shaping optical unit designed for a transparent workpiece is used for the processing of a partly transparent workpiece.

It is possible to identify an intensity longitudinal section 31A through a focal zone and an associated intensity profile 31B along the beam axis 9 of the homogenized Bessel beam, as would be present in the transparent workpiece. The maximum intensity along the beam axis 9 is substantially constant over a significant length (indicated by lines 32A, 32B in FIG. 4) of the quasi-non-diffractive beam—in accordance with the use in a transparent workpiece.

If such a homogenized Bessel beam is now radiated into a partly transparent material, then this yields a dashed intensity profile 31C, in the case of which the intensity along the beam axis 9 decreases continually with penetration depth in the material on account of the linear absorption. A dashed intensity profile 31D shows a corresponding reduction in the intensity for a modulated quasi-non-diffractive beam which forms a plurality of comparable intensity maxima in the propagation direction instead of a homogeneous intensity profile in the transparent material.

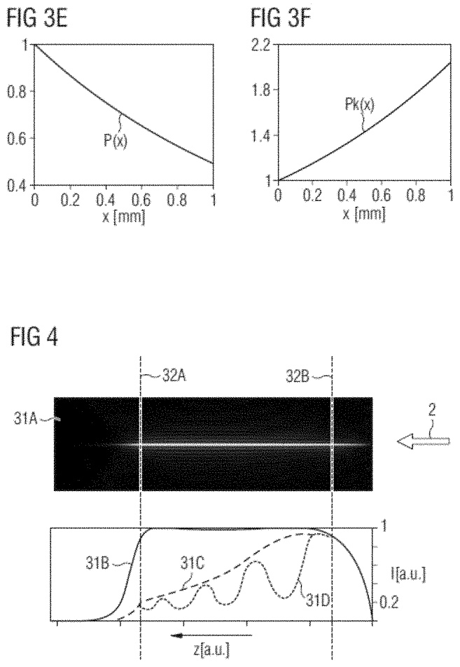

In a flowchart, FIG. 5 elucidates the method, proposed herein, for material processing of a workpiece using a quasi-non-diffractive laser beam, the workpiece having a material which is partly transparent to the quasi-non-diffractive laser beam. Partial transparency means that the material has a laser radiation intensity-independent linear absorption for laser radiation in the frequency range of the quasi-non-diffractive laser beam.

The method comprises step 101, in which a raw laser beam is produced for the beam shaping. In a step 101A, the production of the raw laser beam may produce a laser beam using a laser system (in FIG. 2: laser source 11) with beam parameters designed for the material processing to be carried out (sufficient power, desired pulse duration, etc.). Further, in a step 101B, a geometric beam parameter such as a beam diameter of the raw laser beam can be adjusted to a beam shaping element provided for the phase imposition, in particular to the implemented two-dimensional phase distribution (for example using the beam adjustment optical unit 17A in FIG. 2).

The method further comprises step 103, in which the raw laser beam (in FIG. 2: raw laser beam 5′) is radiated with a raw laser beam intensity (in this case the intensity of the entire raw laser beam 5′) into an optical beam shaping system for beam shaping purposes (in FIG. 2: the optical beam shaping system 13, which optionally comprises the beam adjustment optical unit). In this case, the optical system is configured in such a way that the raw laser beam (once beam shaping has been implemented) is able to form the quasi-non-diffractive laser beam in the workpiece, with a focal zone extending in a longitudinal direction for the purpose of the material processing of the workpiece. By means of the optical beam shaping system there is a phase imposition on a beam cross section of the raw laser beam such that in the focal zone the quasi-non-diffractive laser beam has an intensity distribution which is variable in the longitudinal direction. On account of the beam shaping, portions of the quasi-non-diffractive laser beam arranged in the propagation direction (in FIG. 3: portions 6A, 6B, 6C) are shaped by beam cross-sectional regions of the raw laser beam (in FIG. 2: for example, the ring-shaped cross-sectional areas R_A, R_B, R_C assigned to the beam components 5A, 5B, 5C). In this case, the illustration in FIG. 2 is simplified to the effect of the phase imposition generally being able to be carried out so freely/flexibly that laser radiation can be guided to one position in the focal zone (in the longitudinal direction) from different beam cross-sectional regions of the raw laser beam. In this case, the beam cross-sectional regions of the raw laser beam are assigned intensity components (in FIG. 2: intensity components I_A, I_B, I_C) of the raw laser beam intensity.

Beam shaping of the raw laser beam (step 101A) is carried out by radiating (step 103) the raw laser beam into the optical beam shaping system. Thus, a two-dimensional phase distribution is imposed (step 103A) (in particular using a diffractive optical beam shaping element or using a modified axicon optical unit (modified in the cone angle) for example) on the beam cross section of the raw laser beam 5′ (forming phase-imposed laser radiation). The imposed two-dimensional phase distribution causes the phase-imposed laser radiation from the beam cross-sectional regions of the raw laser beam to be fed to the portions of the quasi-non-diffractive laser beam arranged in the propagation direction.

The object of the phase imposition now is to obtain an at least approximately constant intensity profile over a significant length of the focal zone in the workpiece, to be precise despite the partial transparency of the workpiece.

This is implemented in step 103 by adjusting the phase imposition on the basis of at least one of the intensity components and/or a size of at least one of the beam cross-sectional regions. In this case, the phase imposition is set in such a way that a resultant intensity distribution of the quasi-non-diffractive laser beam upon radiation into the partly transparent material of the workpiece is precisely at least approximately constant in the longitudinal direction at the focal zone. Expressed differently, the adjustment is implemented in such a way that, within the scope of the assignment of the intensity components for the different positions of the focal zone (in the longitudinal direction), there is consideration in each case of an intensity loss which occurs on account of the linear absorption along an optical path from the respective beam cross-sectional region to the associated portion of the quasi-non-diffractive laser beam. In view of the material processing, this consideration is implemented in such a way that the material is modified in the portions of the quasi-non-diffractive laser beam on the basis of a nonlinear absorption which depends on the intensity of the quasi-non-diffractive laser beam in the respective portion.

For example, for the purpose of producing a quasi-non-diffractive laser beam with an aspect ratio of at least 1:10, in particular of at least 1:100, a reduction of an intensity along the quasi-non-diffractive laser beam on account of the linear absorption can be compensated for in at least one portion in step 103. Additionally or alternatively, step 103 may for example comprise that, within the scope of forming the quasi-non-diffractive laser beam in a comparison material which has substantially no linear absorption, an intensity along the quasi-non-diffractive laser beam is variable, for example increases, in the comparison material.

A phase imposition specifically taking account of the linear absorption may be set in the beam shaping system in step 103. By way of example, phase increases in the radial direction to be imposed might be set in a plurality of beam cross-sectional regions (step 103A). Further, geometric parameters (such as size and position) of the beam cross-sectional regions may be adjusted/set in the phase imposition (step 103B). Thus, sizes and/or positions in relation to the raw laser beam of beam cross-sectional regions which are exposed to a uniform phase imposition may be adapted to specified intensity components of the raw laser beam. In addition to discrete, for example ring-shaped, beam cross-sectional regions, various phase impositions may also superpose in one beam cross-sectional region; for example, a plurality of phase increases in the radial direction may be implemented simultaneously in a beam cross-sectional region in order to feed laser radiation from this beam cross-sectional region to a plurality of positions along the optical axis.

Additionally or alternatively, a beam diameter of the raw laser beam at the beam shaping optical unit can furthermore be set in step 103 in order to set intensity components of the raw laser beam assigned to the beam cross-sectional regions (R_A, R_B, R_C) (step 103C). Thus, the beam diameter can be increased or reduced in order to even use a phase imposition, which was designed for a different linear absorption than that of a material present for processing purposes, for the other linear absorption.

In a step 105, beam parameters of the laser beam such as pulse duration and pulse energy can be corrected such that the material of the workpiece is (structurally) modified in the quasi-non-diffractive beam.

The phase-imposed laser radiation is focused into the partly transparent material of the workpiece in a step 107; that is to say, at least some of the quasi-non-diffractive laser beam is positioned in the workpiece in such a way that the arising linear absorption is at least partly compensated for by the phase imposition.

Further, a relative movement between the workpiece and the quasi-non-diffractive laser beam can be brought about in a step 109, in the case of which the quasi-non-diffractive laser beam is repeatedly positioned along a scanning trajectory in the material of the workpiece such that arranged/strung-together modifications are written into the material of the workpiece along the scanning trajectory.

FIGS. 6A and 6B elucidate a modified geometry of an axicon for a homogenized Bessel-Gaussian beam for processing a partly transparent material. FIG. 6A shows a linear decrease in the thickness d of a conventional axicon with distance from the optical axis 9. In contrast thereto, FIG. 6B shows a decrease in the thickness d for an appropriately modified axicon. It is possible to identify an initially (radially inner) increased reduction in the thickness d, followed by a slower reduction in the thickness d, and then followed by an increased reduction in the thickness d. The variation in the thickness d causes intensity components to be shifted/refracted backward into the quasi-non-diffractive laser beam in the propagation direction. The arising homogenized intensity distribution in the partly transparent workpiece then preferably corresponds to the intensity distribution, already shown in FIG. 4, for the processing of a substantially transparent material.

As already mentioned, a corresponding phase imposition can alternatively or additionally be carried out in reflective fashion or using a diffractive optical beam shaping element.

FIG. 6C shows a phase profile oscillating between +71 and −71 (calculated in a thin element approximation), as may be reproduced with phase shift values of a diffractive optical beam shaping element. Setting the phase imposition with a diffractive optical beam shaping element comprises, in a rotationally symmetrical case, a setting in the radial direction of (sawtooth-shaped) phase increases impressed on beam cross-sectional regions of the raw laser beam.

Specifically, FIG. 6C shows the phase profile corresponding to phase imposition in a central region of the modified axicon of FIG. 6B; that is to say, the phase profile reproduces the height profile of the modified axicon. In FIG. 6B, it is possible only with difficulties to identify how the oscillation of the phase shift values between +π and −π varies in terms of its oscillation frequency in the radial direction so as to understand the deviation from the fixed cone angle.

FIG. 7 elucidates the formation of intensity distributions for the material processing of partly transparent workpieces using a rotationally symmetric optical beam shaping system and correspondingly rotationally symmetric laser beams and intensity distributions.

FIG. 7 shows the raw laser beam 5′, just before it is incident on a conventional axicon 15B or a modified axicon 15C. Further, FIG. 7 shows schematic intensity distributions as they occur on account of the beam shaping, to be precise, plotted above, in a substantially transparent material, which is to say without linear absorption (intensity I(−)), and, plotted below, in a partly transparent material, which is to say with linear absorption (intensity I(+)).

In the case of an incident Gaussian beam (exemplary intensity distribution G_1), the conventional axicon 15B shapes a Bessel-Gaussian beam with a longitudinal intensity distribution BG_1(−) in the transparent material and a deformed Bessel-Gaussian beam with a longitudinal intensity distribution BG_1(+) in the partly transparent material, with the intensity distribution BG_1(+) reducing more quickly in the propagation direction than the intensity distribution BG_1(−) on account of the linear absorption.

For the processing of a transparent material, the modified axicon 15B may for example be modified in such a way that, in the case of an incident Gaussian beam with the intensity distribution G_1 and the corresponding beam diameter D_1 in the transparent material, a Bessel-Gaussian beam which is homogenized in the propagation direction and which has a homogenized intensity distribution BG_h(−) (corresponding to 31B in FIG. 4) is formed. As is likewise indicated in FIG. 4, this homogenized intensity distribution is deformed when radiated into a partly transparent material (intensity distribution BG_h(+); corresponding to 31C in FIG. 4) on account of the linear absorption. Provided appropriate beam parameters of the raw laser beam 5′ such as pulse duration and pulse energy were set, the homogenized intensity distribution BG_h(−) is able to produce intensities which, over a length L(−) in the propagation direction, lead to nonlinear absorption/interaction with the transparent material. From the intensity distribution BG_h(+), it is evident that this length is substantially shortened when radiating into a partly transparent material.

To compensate the linear absorption, the phase imposition, which is to say the reduction in the thickness d of the axicon with distance from the beam axis 9 in the example of the modified axicon and the adjustment of the phase shift values in the case of a diffractive optical element, can be adapted in order to bring about an at least approximately constant intensity distribution in the longitudinal direction z by “redistributing the intensity components”.

If the intensity components are redistributed in such a way that the increase in the propagation direction is adapted to the linear absorption and the intensity reduction is substantially compensated, then it is possible in this way for a harmonized intensity distribution BG_2h(+) to be formed in the partly transparent material. In this way, the homogenized intensity distribution BG_2h (+) is able to produce intensities which—provided appropriate beam parameters of the raw laser beam 5′ were radiated in—lead to a nonlinear absorption/interaction with the partly transparent material in the propagation direction over a length L(+). Provided an appropriate laser power is available, the length L(+) can be dimensioned to be comparable to the length L(−). If such a phase-imposed laser beam were to be radiated into a transparent material, this would lead to an intensity distribution BG_2(−) along the quasi-non-diffractive laser beam which increases with penetration depth.

Alternatively or additionally, the beam diameter of the incident raw laser beam 5′ can also be increased (beam diameter D_2 in FIG. 7) in order to compensate the linear absorption, for example using the telescope 17A. This increases the intensity component in the cross-sectional regions R_B, R_C. Since the outer beam components contribute to the back portions 6B_T, 6C_T of the quasi-non-diffractive laser beam, for example within the scope of the phase imposition for the homogenized intensity distribution BG_h(−), the absorption in the partly transparent material can be compensated for in at least one portion by increasing the beam radius in the case of a Bessel-Gaussian beam (for example, proceeding from a phase imposition for an intensity distribution BG_h(−) which is homogenized in the transparent material). Expressed differently, the intensity along the quasi-non-diffractive laser beam can be present at least approximately in constant fashion (similar to the homogenized intensity distribution BG_2h (+)). The intensity in the transparent material would increase along the quasi-non-diffractive laser beam (intensity distribution BG_2(−)). It should be observed that the intensity profiles in FIG. 7 are depicted schematically in order to indicate increases or decreases in intensity, with even the exponential influences of the linear absorption being indicated schematically.

As indicated in the context of FIG. 7, differences in the intensity distributions for the transparent material and partly transparent material, respectively, arise when using a beam shaping optical unit, which was optimized for a transparent material, with an adapted beam diameter. A person skilled in the art will acknowledge that this can be traced back to the approximate adjustment of the intensity components within the scope of a pure beam expansion. Further, intensity distributions which are suitable both for transparent materials in the case of a given beam diameter and for partly transparent materials in the case of a different beam diameter can be produced in mixed configurations of the beam shaping optical unit.

In an illustration, FIG. 8 elucidates details regarding a quasi-non-diffractive laser beam with a central intensity maximum, which was produced in a partly transparent material. Subfigure (a) shows a section in the propagation direction (z-direction), in which it is possible to identify the pronounced central intensity maximum, which is accompanied by radially outer (ring-shaped) secondary maxima. Subfigure (b) shows an intensity profile in the z-direction, which forms a plateau over substantially the entire length (homogenized intensity distribution). Subfigures (c1), (c2), and (c3) each show an intensity profile (beam profile) in a transverse sectional plane (x-y-plane), at the start, in the center, and at the end of the plateau.

The mid-beam profile at z=75 a.u. (center of the plateau) scales in terms of the transverse dimensions by approximately a factor of 2 in comparison with the profiles at z=10 a.u. (start of the plateau) and z=110 a.u. (end of the plateau). For example, this is identified from the diameter of the central maximum. The variations in the diameter of the central maximum can be traced back to the fact that a plurality of entry angles contribute and a transverse extent of the quasi-non-diffractive laser beam depends on contributing entry angles with respect to the optical axis at a position of the focal zone in the longitudinal direction.

In general, when using a contribution of a plurality of entry angles for the intensity at a position in the longitudinal direction, care has to be taken that the entry angles (for an intensity that is as constant as possible throughout) do not, where possible, lead to a phase shift that causes destructive interference. Thus, laser radiation guided to the at least one position of the plurality of positions at a first angle preferably has a phase difference of less than ±π/4 with respect to laser radiation guided to the (same) at least one position of the plurality of positions at a second angle.

For the sake of completeness, it is noted that, for an inverse Bessel-Gaussian beam homogenized for a partly transparent material, beam contributions of the center of the incident raw laser beam contribute to the intensity at the end of the quasi-non-diffractive laser beam. If an intensity increase (without linear absorption) should be obtained along the quasi-non-diffractive laser beam for such a homogenized inverse Bessel-Gaussian beam, then a corresponding reduction in the beam cross section is necessary in order to accordingly increase intensity components which are assigned to the downstream portions of the quasi-non-diffractive laser beam.

Subfigures (d) and (e) in FIG. 8 show, in exemplary fashion, central portions of diffractive optical elements/imposed phase profiles for the purpose of forming inverse Bessel-type beams. Mutually adjoining surface elements 15a which construct an extensive grating structure are schematically indicated in each case. Each of the surface elements 15a is assigned a phase shift value which is imposed on passing laser radiation. The phase shift values in the grating structure together form a phase mask, through which the raw laser beam passes in order to experience a corresponding phase imposition.

Subfigure (d) belongs to a phase mask for implementing an ideal (inverse) axicon (the period does not change when passing through the phase shift values). A phase imposition using such a diffractive optical element can be used to form an intensity distribution in accordance with FIG. 1, subfigure (f).

Subfigure (e) belongs to a phase mask for implementing a modified (inverse) axicon (the periods when passing through the phase shift values are radius-dependent). The phase distribution is designed precisely so that, for a specific beam diameter, a longitudinal homogenization is to be expected in the partly transparent workpiece when taking account of the associated absorption coefficient. If a larger beam diameter is chosen, it is possible to a good approximation to produce an intensity profile of an inverse homogenized Bessel beam in a transparent material, which comes close to that shown in FIG. 4.

It is noted that, in respect of subfigures (d) and (e) in FIG. 8, complex-conjugate phase distributions (inverted sign of the phase shift values) allow the implementations of corresponding real axicon optics.

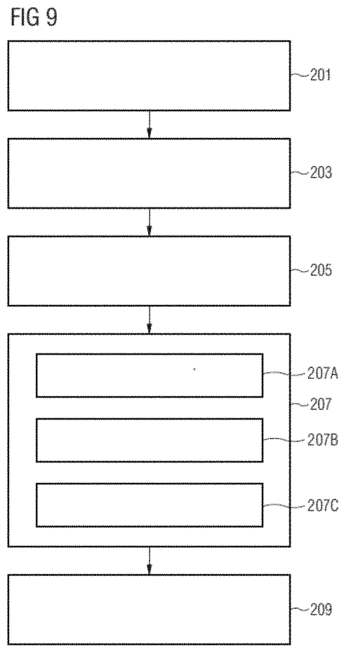

FIG. 9 shows a flowchart for explaining a method for forming a beam shaping element provided for use within the scope of material processing of a partly transparent workpiece in an optical system for the shaping of a quasi-non-diffractive laser beam (with an intensity distribution resulting from the phase imposition) from a raw laser beam. The object is to set a phase imposition for a specified transverse intensity distribution of the raw laser beam, in particular for a specified beam diameter of the raw laser beam, and a specified linear absorption of the partly transparent material of the workpiece. Using the method, it is possible, in particular, to determine the phase profile of a phase mask which is produced using a diffractive optical element.

The absorption behavior of the material to be processed is given. By way of example, by measuring the intensity Pd in FIG. 3D, it is possible to provide a linear absorption parameter (the “optical depth i”) of the partly transparent material in the frequency range of the quasi-non-diffractive laser beam (step 201). On the basis thereof, the target intensity distribution on the optical axis in the workpiece required to modify the material, for example over the entire thickness d or over a desired length, is calculated (or defined) (step 203). A target intensity distribution in the workpiece along an optical axis of the quasi-non-diffractive laser beam can be defined in such a way that, in the target intensity distribution, there is present in at least one portion an intensity above an intensity threshold, which is required for a nonlinear absorption, dependent on a respectively present laser radiation intensity, for the purpose of modifying the material of the workpiece at a plurality of positions along the optical axis.

For the determination of the phase distribution, a transverse beam profile of the raw laser beam (intensity profile) on which the phase distribution should be imposed should also be specified (step 205).

Then, an optical design of an axicon-like element (e.g., a modified refractive or reflective axicon or diffractive optical element) is calculated for the target intensity distribution (step 207):
Proceeding from a phase imposition with an axicon (gradient angle/phase increase is constant), there is a subdivision into radial elements in which the gradient angle can be modified. A phase increase corresponds to an entry angle at which laser radiation is guided with respect to the optical axis. (Subdividing the transverse beam profile into beam cross-sectional regions, in particular beam cross-sectional regions with a ring-shaped form, (corresponding to zones of the DOE or radial regions of the axicon)—step 207A—and assigning phase increases, in particular identical linear phase increases, in the radial direction over the beam cross-sectional regions as an initial phase distribution—step 207B)
A change in the gradient angles in the radial elements leads to a new height profile of the now modified axicon with a correspondingly modified phase imposition. In conjunction with the known power components of the raw beam, this leads to a calculable redistribution of the power input into the focal zone.
An adjustment, for example an iterative adjustment, of the gradient angles can be carried out until the desired target intensity distribution is present. (Iteratively adjusting the phase increases in the beam cross-sectional regions and calculating the intensity distribution along the optical axis setting-in in the workpiece after the raw laser beam has passed through the optical system while taking account of the linear absorption parameter, until a phase distribution which compensates the linear absorption is present, by way of which the target intensity distribution along the optical axis in the workpiece arises—step 207C)

The iteratively adjusted phase increases of the phase distribution compensating the linear absorption, in conjunction with intensity components of the raw laser beam present in the beam cross-sectional regions, can bring about a redistribution along the optical axis of the laser radiation contributing to the quasi-non-diffractive laser beam in order to form the target intensity distribution.

To form the beam shaping element, the beam shaping element is provided with the phase distribution which compensates for the linear absorption (step 209). To this end, a specific height profile for an optical material/mirror can be derived from the compensating phase distribution, in order to shape a refractive or reflective optical axicon element with the height profile from the optical material as the thickness profile of an optical material or mirror profile. Further, a diffractive implementation of the compensating phase distribution can be implemented using a diffractive optical element (e.g., a Fresnel axicon-like diffractive optical element, the phase shift values of which are fixedly set, or a spatial light modulator, the phase shift values of which were set in accordance with the phase distribution which compensates for the linear absorption).

The compensating phase distribution with the plurality of contributing cone angles leads to the laser beam being able to be considered as a plurality of component beams, with each of the component beams being able to have a different entry angle, at which it enters the workpiece and travels toward the optical axis. The entry angles determined according to the method depend on the position and the intensities in the respective beam cross-sectional regions of the raw laser beam.

On account of the phase distribution which compensates the linear absorption, laser radiation is guided at a plurality of angles to at least one position of a plurality of positions along the optical axis. By way of example, the beam cross-sectional regions of the raw laser beam comprise at least two beam cross-sectional regions with a ring-shaped form. The phase increases for the two beam cross-sectional regions with a ring-shaped form can be set in such a way that laser radiation from the two beam cross-sectional regions with a ring-shaped form is fed to a joint position of the plurality of positions at two different cone angles.

The terms of “beam cross-sectional region” and associated “portion of the quasi-non-diffractive beam”, introduced herein to describe the concepts, and the identification thereof in the figures do not force a fixed assignment of a surface region to a portion. Rather, a beam cross-sectional region of a diffractive optical beam shaping element may also supply a plurality of portions of the quasi-non-diffractive beam with laser radiation, for example if diffraction structures are placed one above the other. A person skilled in the art will also understand that there need not be any restriction to discrete portions in this case, but instead that continuous portions are also included as a limiting case; see the example of the modified axicon with a homogenized intensity distribution shown in FIG. 7.

In view of the material processing of a partly transparent material including the nonlinear absorption of the material, a quasi-non-diffractive laser beam may bring about a modification in the material which extends over the entire length of the quasi-non-diffractive laser beam. A person skilled in the art will acknowledge that, on the basis of the concepts disclosed herein, it is also possible to produce linearly strung-together/arranged modification zones or for example an extensive arrangement of modification zones with the quasi-non-diffractive laser beam. To this end, it is possible to use beam shaping which for example produces strung-together local intensity maxima in the propagation direction (see FIG. 4). The intensity maxima can be delimited by an envelope profile. The envelope profile may likewise be shaped and for example correspond in terms of its profile to the intensity profiles shown in FIG. 7.

A partly transparent workpiece into which a plurality of modifications that are spaced apart or merge into one another have been introduced can be present as a result of the laser-based material processing. The modifications can additionally form cracks in the material which extend into the material of the workpiece between adjacent modifications or generally randomly proceeding from one of the modifications.

For the sake of completeness, it is pointed out that besides an intensity distribution in a focal zone which brings about a single symmetrical modification, a phase imposition can be performed by means of a diffractive optical element, for example, which results in an intensity distribution in the focal zone which brings about one asymmetrical modification (e.g., flattened in one direction) or a plurality of modifications running parallel to one another (see subfigure (c) in FIG. 1). In general, the modification or the arrangement of modifications can be produced by means of one laser pulse or a group of laser pulses. Exemplary phase impositions and intensity distributions are disclosed for example in the applicant's German patent application 10 2019 128 362.0, “Segmentiertes Strahlformungselement und Laserbearbeitungsanlage” [Segmented beam shaping element and laser processing apparatus], with a filing date of Oct. 21, 2019, and also in Chen et al., “Generalized axicon-based generation of nondiffracting beams”, arXiv:1911.03103v1 [physics.optics] Nov. 8, 2019.

Such asymmetrical modifications or strung-together modifications can likewise be combined with the concepts disclosed herein for the processing of partly transparent materials. In other words, a beam shaping which should be carried out for such asymmetric modifications can also be combined with a phase imposition which can compensate for the influence of the intensity along the quasi-non-diffractive beam during the propagation through the material.

It is explicitly emphasized that all features disclosed in the description and/or the claims should be regarded as separate and independent of one another for the purpose of the original disclosure and likewise for the purpose of restricting the claimed invention independently of the combinations of features in the embodiments and/or the claims. It is explicitly stated that all range indications or indications of groups of units disclose any possible intermediate value or subgroup of units for the purpose of the original disclosure and likewise for the purpose of restricting the claimed invention, in particular also as a limit of a range indication.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Laser processing apparatus 1
Arrows 2
Workpiece 3
Quasi-non-diffractive (laser) beam 5
Raw laser beam 5′
Laser beam 5″
Phase-imposed laser radiation 5_PH
Beam components 5A, . . .
Components of the optical paths in the material 5A′, 5B′ and 5C′
Laser radiation 5A_T . . . Portions of the quasi-non-diffractive laser beam 6A, . . .
Portions 6A_T, 6B_T, 6C_T along the optical axis 9
Focal zone 7
Beam axis 9
Laser beam source 11
Optical beam shaping system 13
Beam shaping optical unit 15
Beam adjustment optical unit 17A
Imaging system 17B
Workpiece mount 19
Controller 21
Connections 21A
Intensity cross section 31A, 41
Intensity profile 31B, 31C, 31D
Lines 32A, 32B, 42A, 42B, 44A, 44B
High intensity becomes 41A
Maximum 41B
Boost 41C
Steps 101, 103 . . .
Diameter D
Focal length f1, f2
Far-field distribution F, F_T
Position of the far-field distribution P_F
Gaussian intensity distribution G
Intensity components I_A, . . .
Intensity diagram I(y)
Length L
Beam cross-sectional regions R_A, . . .
Telescope lens L1_A/B, L2_A/B
Scanning trajectory T
Entry angle δ, δ′

1. A method for material processing of a workpiece, the method comprising:
radiating a pulsed raw laser beam into an optical beam shaping system in order to form a quasi-non-diffractive laser beam with a focal zone extending in a longitudinal direction for the material processing of the workpiece, wherein the optical beam shaping system is configured to impose a phase onto a beam cross section of the raw laser beam for forming phase-imposed laser radiation, and
focusing the phase-imposed laser radiation into the workpiece so that the quasi-non-diffractive laser beam is formed and the focal zone has an intensity distribution that is adjustable along the longitudinal direction, wherein the workpiece comprises a material that is partly transparent to the quasi-non-diffractive laser beam and exhibits an intensity-independent linear absorption in a frequency range of the quasi-non-diffractive laser beam, and wherein the phase imposed on the beam cross section of the raw laser beam is set so that the intensity distribution of the quasi-non-diffractive laser beam in the focal zone is at least approximately constant in the longitudinal direction.

2. The method as claimed in claim 1, wherein the phase imposed on the beam cross section of the raw laser beam is set so that the phase-imposed laser radiation is guided to a plurality of positions in the workpiece along an optical axis in an entry angle range with respect to the optical axis comprising entry angles ranging from 5° to 25° in the partly transparent material of the workpiece, and that the intensity distribution at the plurality of positions results from intensity losses due to the linear absorption during a propagation of the phase-imposed laser radiation to the plurality of positions in the partly transparent material, and
wherein the phase imposed on the beam cross section of the raw laser beam is set so that the phase-imposed laser radiation is guided at a plurality of angles from the entry angle range at at least one position of the plurality of positions such that an intensity threshold for a nonlinear absorption is exceeded at the plurality of positions in the partly transparent material despite the intensity losses, wherein a nonlinear absorption in the partly transparent material depends on a respectively present intensity of the phase-imposed laser radiation.

3. The method as claimed in claim 2, wherein laser radiation guided to the at least one position of the plurality of positions at a first angle has a phase difference of less than pi/4 with respect to laser radiation guided to the at least one position of the plurality of positions at a second angle, and/or
wherein the phase imposed on the beam cross section of the raw laser beam is set so that the phase-imposed laser radiation is guided rotationally symmetrically to the plurality of positions so that each of the plurality of angles represents a local cone angle.

4. The method as claimed in claim 1, wherein the phase is set by setting phase increases in a radial direction in beam cross-sectional regions of the raw laser beam, and/or by setting geometric parameters of the beam cross-sectional regions.

5. The method as claimed in claim 4, wherein the beam cross-sectional regions comprise at least two beam cross-sectional regions formed in a ring-shaped or ring-segment-shaped fashion, and the phase increases for the two beam cross-sectional regions are set in such a way that laser radiation from the two beam cross-sectional regions is fed to a joint position of the plurality of positions at two different cone angles.

6. The method as claimed in claim 4, further comprising setting intensity components of a raw laser beam intensity, wherein the intensity components are assigned to the beam cross-sectional regions, so as to bring about the intensity distribution) of the quasi-non-diffractive laser beam in the focal zone.

7. The method as claimed in claim 2, wherein the phase is set for a specified transverse intensity distribution of the raw laser beam, and for a specified linear absorption of the partly transparent material of the workpiece, and
wherein, in an unchanged phase imposition, the transverse intensity distribution of the raw laser beam is adjusted for a material with a linear absorption that deviates from the specified linear absorption of the partly transparent material, in order to increase or decrease an intensity component of a raw laser beam intensity fed to a position of the plurality of positions.

8. The method as claimed in claim 1, wherein the phase is set so that an intensity decrease of the quasi-non-diffractive laser beam on account of the linear absorption in the partly transparent material is compensated for in at least one portion.

9. The method as claimed in claim 1, wherein the intensity distribution of the quasi-non-diffractive laser beam or an envelope of the intensity distribution along the optical axis comprises deviations from an average intensity of the quasi-non-diffractive laser beam of an order of up to 10%, with the average intensity referring to a part of the focal zone in which there is a nonlinear interaction with the material of the workpiece, and
wherein the intensity distribution or the envelope of the intensity distribution is substantially constant.

10. The method as claimed in claim 2, wherein the partly transparent material is modified due to nonlinear absorption at the plurality of positions in the focal zone despite the intensity losses, and modification of the partly transparent material
extends over a length of the quasi-non-diffractive laser beam or
comprises a stringing of modification zones along the quasi-non-diffractive laser beam.

11. The method as claimed in claim 1, wherein the raw laser beam has a Gaussian transverse intensity profile, and the optical beam shaping system is configured to shape the quasi-non-diffractive laser beam as a Bessel-Gaussian beam, and/or
wherein a transverse extent of the quasi-non-diffractive laser beam in the focal zone changes along the optical axis, and/or
wherein the transverse extent of the quasi-non-diffractive laser beam at a position in the focal zone depends on angles of incidence with which laser radiation is incident on the optical axis at the position in the focal zone for forming the quasi-non-diffractive laser beam.

12. The method as claimed in claim 1, further comprising:
setting beam parameters of the raw laser beam so that the partly transparent material of the workpiece is modified, and/or
positioning at least one portion of the quasi-non-diffractive laser beam in the workpiece, and/or
bringing about a relative movement between the workpiece and the quasi-non-diffractive laser beam, wherein the quasi-non-diffractive laser beam is moved along a scanning trajectory in the workpiece such that strung-together modifications are written into the workpiece along the scanning trajectory.

13. The method as claimed in claim 1, wherein the optical beam shaping system comprises a diffractive optical beam shaping element, the diffractive optical beam shaping element has mutually adjoining surface elements that construct an extensive grating structure, each surface element being assigned a phase shift value, with the phase shift values defining a two-dimensional phase distribution in accordance with the phase imposed on the raw laser beam, and
wherein as the raw laser beam is radiated into the optical beam shaping system, the phase is imposed on the raw laser beam by the diffractive optical beam shaping element due to the phase distribution.

14. A laser processing apparatus for material processing of a workpiece using a quasi-non-diffractive laser beam, the workpiece having a material that is partly transparent to the quasi-non-diffractive laser beam and exhibits a laser radiation intensity-independent linear absorption in the frequency range of the quasi-non-diffractive laser beam, the laser processing apparatus comprising:
a laser beam source configured to emit a pulsed laser beam, and
an optical beam shaping system for beam shaping of the laser beam for forming the quasi-non-diffractive laser beam with a focal zone extending in a longitudinal direction, the optical beam shaping system comprising:
a beam adjustment optical unit configured to output the laser beam as a raw laser beam with a beam diameter, and
a beam shaping element configured to impose a phase on a beam cross section of the raw laser beam in order to form phase-imposed laser radiation for a specified beam diameter of the raw laser beam so that, as the phase-imposed laser radiation is focused into the partly transparent material of the workpiece, the quasi-non-diffractive laser beam is produced with a resultant intensity distribution that is at least approximately constant in the longitudinal direction in the focal zone,
the laser processing apparatus further comprising a workpiece mount for mounting the workpiece, with the optical beam shaping system and/or the workpiece mount being configured to bring about a relative movement between the workpiece and the quasi-non-diffractive laser beam, wherein the quasi-non-diffractive laser beam is positioned along a scanning trajectory in the material of the workpiece.

15. The laser processing apparatus as claimed in claim 14, wherein the phase imposed on the beam cross section of the raw laser beam is set so that laser radiation of the raw laser beam is guided to a plurality of positions in the workpiece along an optical axis, in an entry angle range with respect to the optical axis, and forms the quasi-non-diffractive laser beam at the plurality of positions, and
wherein intensity losses occur due to the linear absorption during propagation of the laser radiation to the plurality of positions in the partly transparent material, and the phase is further set so that laser radiation is guided at a plurality of angles from the entry angle range to at least one position of the plurality of positions such that an intensity threshold for a nonlinear absorption is exceeded at the plurality of positions in the partly transparent material despite the intensity losses.

16. The laser processing apparatus as claimed in claim 14, further comprising:
a controller configured to set the beam adjustment optical unit so that the beam diameter at the beam shaping element is larger or smaller than the specified beam diameter so as to compensate for variations in the linear absorption.

17. The laser processing apparatus as claimed in any of claim 14, wherein the beam shaping element is a diffractive optical element, a spatial light modulator, or a modified refractive or reflective axicon.

18. The laser processing apparatus as claimed in claim 14, wherein the phase is designed so that the resultant intensity distribution) or an envelope of the resultant intensity distribution comprises deviations from an average intensity of the quasi-non-diffractive laser beam of an order of up to 10%, with the average intensity referring to a part of the focal zone in which there is a nonlinear interaction with the material of the workpiece, and
wherein the resultant intensity distribution or the envelope of the resultant intensity distribution is substantially constant.

19. A method for forming a beam shaping element of an optical beam shaping system for beam shaping of a quasi-non-diffractive laser beam from a raw laser beam, the quasi-non-diffractive laser beam for material processing of s workpiece having a material that is partly transparent to the quasi-non-diffractive laser beam and exhibits a laser radiation intensity-independent linear absorption in a frequency range of the quasi-non-diffractive laser beam, the method comprising:
providing a linear absorption parameter of the partly transparent material in the frequency range of the quasi-non-diffractive laser beam;
defining a target intensity distribution as a resultant intensity distribution to be obtained in the workpiece along an optical axis of the quasi-non-diffractive laser beam, wherein an intensity of the target intensity distribution is, in at least one portion, above an intensity threshold for a nonlinear absorption, for modifying the material of the workpiece at a plurality of positions along the optical axis;
specifying a transverse beam profile of the raw laser beam, onto which a two-dimensional phase distribution is imposed;
calculating the two-dimensional phase distribution for the transverse beam profile by:
subdividing the transverse beam profile into beam cross-sectional regions with a ring-shaped form,
assigning phase increases in a radial direction over the beam cross-sectional regions as an initial phase distribution, and
iteratively adjusting the phase increases in the beam cross-sectional regions and calculating the intensity distribution along the optical axis setting-in in the workpiece after the raw laser beam has passed through the optical beam shaping system while taking account of linear absorption specified by the linear absorption parameter, until a two-dimensional phase distribution that compensates the linear absorption is present, so that the target intensity distribution along the optical axis in the workpiece arises as the resultant intensity distribution); and
providing the beam shaping element with the two-dimensional phase distribution that compensates the linear absorption.

20. The method as claimed in claim 19, wherein the iteratively adjusted phase increases, in conjunction with intensity components of the raw laser beam present in the beam cross-sectional regions, bring about a redistribution along the optical axis of the laser radiation contributing to the quasi-non-diffractive laser beam in order to form the target intensity distribution.

21. The method as claimed in claim 19, wherein a phase increase corresponds to an angle at which laser radiation is guided with respect to the optical axis, and
wherein the two-dimensional phase distribution that compensates the linear absorption is determined iteratively so that laser radiation is guided at a plurality of angles to at least one position of a plurality of positions along the optical axis.

22. The method as claimed in claim 19, wherein the beam shaping element has mutually adjoining surface elements, the surface elements are provided with phase shift values that are set in accordance with the two-dimensional phase distribution that compensates the linear absorption, and
wherein the beam shaping element is designed as
a Fresnel-axicon-like diffractive optical element, wherein the phase shift values of the diffractive optical element are fixedly set, or
a spatial light modulator, wherein the phase shift values of the spatial light modulator are set in accordance with the phase distribution that compensates the linear absorption.

23. The method as claimed in claim 19 further comprising:
deriving a height profile from the two-dimensional phase distribution that compensates the linear absorption, with a local height corresponding to a local phase shift value, and
forming a refractive or reflective axicon optical unit with the height profile as the beam shaping element.
